(19) United States
(12) Patent Application Publication
(10) Pub. No.: US 2025/0362437 A1
(43) Pub. Date: Nov. 27, 2025

(54) METASURFACE MODULE AND OPTICAL DEVICE

(71) Applicant: Chiun Mai Communication Systems, Inc., New Taipei (TW)

(72) Inventors: AMIR HASSAN FIROOZI, New Taipei (TW); CHEN-SHENG HSU, New Taipei (TW)

(21) Appl. No.: 19/215,598

(22) Filed: May 22, 2025

Related U.S. Application Data
(60) Provisional application No. 63/651,374, filed on May 23, 2024.

(51) Int. Cl. G02B 5/18; G02B 1/00; G02B 27/01

(52) U.S. Cl. CPC G02B 5/1861; G02B 1/002; G02B 5/1814; G02B 5/1842; G02B 27/0101

(57) ABSTRACT

A metasurface module and an optical device are provided, the metasurface module includes a DBR layer and a metasurface layer arranged on the DBR layer, the DBR layer includes at least one DBR, the metasurface layer includes a plurality of nanostructures arranged on the DBR layer, the plurality of nanostructures arranged in a predetermined configuration, the plurality of nanostructures configured to change a light modulation of lights emitted from a light source and separate a spectral of the light to a plurality of specific bands.

### CROSS-REFERENCE TO RELATED APPLICATIONS

This application claims priority to U.S. provisional Application No. 63/651,374 filed on May 23, 2024, in the United States Patent and Trademark Office (USPTO), the contents of which are incorporated by reference herein.

### FIELD

The subject matter herein generally relates to optical technologies, and more particularly to a metasurface module, an AR/VR/MR glasses, sensing (such as time of flight), and spectroscopy application thereof.

### BACKGROUND

Anaglyph and stereoscopic 3D imaging commonly use glasses with two different complimentary color bands or different polarizations. These methods are both inexpensive and compatible with full-color displays and projectors. However, these techniques in particular anaglyph suffer from unsatisfying 3D image rendering due to inaccurate color reproduction (color distortion) and retinal rivalry which could cause visual fatigue. To mitigate retinal rivalry, each eye should receive more chromatic information. With current anaglyphs (e.g., red-cyan, green-magenta, yellow-blue) one eye receives one primary color, while the second eye receives two primary color bands (e.g., cyan is the combination of blue and green).

In addition, crosstalk, also known as ghosting, hinders the ability of the brain to fully obtain a true-color 3D image out of two slightly different images perceived by each eye. As the result, the crosstalk signal into red and blue pixels usually comes from green pixels which leaks the red and blue pixel spectra into the green region. Likewise, green pixels receive crosstalk signal from two red and two blue pixels. Therefore, imperfect bandpass color filter causes color leakage from one channel to another which makes users feel uncomfortable. Here, a proposed metasurface module is disclosed as a metasurface-based color filter, which can carefully tune the band for each color to avoid overlapping.

Moreover, each eye can see chromatically opposite color with different polarization respect to another eye. The proposed metasurface module can support modulation of a single color or multi-color with a vast freedom of design and accurate adjustment of the band for each color. In addition, this paradigm can be readily integrated to available AR/VR/MR glasses such as waveguide, pancake, birdbath, and free-form based optical elements. Moreover, the implementation of the proposed metasurface module is not limited only to the above-mentioned applications, instead it has potential to be utilized in other applications such as spectroscopy, sensing, time of flight (ToF), orbital angular momentum (OAM) generator and sorter, and metalenses.

### PRIOR ARTS

1. Chromatically opposite color filter (see FIG. 1A), cross-polarized (see FIG. 1B), active shutter-based (see FIG. 1C), such as liquid crystal glasses (not shown) were previously studied, as shown in FIGS. 1A-1D. As shown in FIG. 1B, the cross-polarized glasses are the most common glasses in 3D theatre. However, due to the following fundamental challenges and issues are not the most demanding glasses in the market. Color reproduction is usually poor.
2. Uncomfortable for long time watching (depth continuity issue).
3. Ghosting can be mitigated at the cost of removing a bit of the opposite color in the source picture which leads to a poor color reproduction.
4. Although, the algorithms for color-space mapping to reproduce true color are not workable when the crosstalk exists.

Therefore, there is a need to seamlessly control the crosstalk by creating perfect color filters and reexamine anaglyph as a high-end 3D image rendering paradigm. Besides, allowing each eye see more color bands at different polarization to ensure left eye only sees the content for the left eye, so does the right eye.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1A illustrates one 3D image glasses with color filter glasses, with cyan and red color band for example (i.e., the color band can be any complimentary color bands such as red-cyan, green-purple, yellow-blue) in prior art.

FIG. 1B illustrates another 3D image glasses with cross-polarized glasses, either linear polarizer or circular polarizer in prior art.

FIG. 1C illustrates one 3D image glasses with shutter-glasses which flip between images quicker than the human eye detection rate (frame per second) to deliver an illusion of motion in prior art.

FIG. 1D illustrates one 3D image glasses with capturing the ambient objects through the cameras then reconstructing a 3D image out of the objects there and display it to the users via AR/VR/MR glasses' display in prior art.

FIG. 2A illustrates an application of the proposed metasurface element or proposed metasurface module on waveguide-based AR/VR/MR glasses according to one embodiment of the present application.

FIG. 2B illustrates an application of the proposed metasurface element or proposed metasurface module on pancake-based AR/VR/MR glasses according to another embodiment of the present application.

FIG. 2C illustrates an application of the proposed metasurface element or proposed metasurface module on a freeform-based AR/VR/MR glasses according to a further embodiment of the present application.

FIG. 3 illustrates a schematic diagram of AR/VR/MR glasses including the proposed metasurface module according to one embodiment of the present application.

FIGS. 4A-4H illustrate examples of a nanostructure, a unit of DBR layer, and a metasurface module with passive and active types according to some embodiments of the present application.

FIGS. 5A-5F illustrate top views of geometrical shapes of one or more nanostructures according to some embodiments of the present application.

FIGS. 6A-6C illustrate the embodiment of metasurface module and two types of pitch definition applied in each two adjacent units of metasurface module 60U. FIG. 6A shows embodiment of a metasurface module 60. FIG. 6B shows one embodiment of one type of pitch definition (center to center) applied in each two adjacent units of metasurface module 60U. FIG. 6C shows one embodiment of another type of pitch definition (edge to edge) applied in each two adjacent units of metasurface module 60U. Wherein, the metasurface module 60 can be composed by multiple units of metasurface module 60U.

FIG. 7 illustrates a schematic diagram of a DBR-based metasurface module 60 with multi-pair of high refractive index material layer and low refractive index material layer and top view of a single square arrangement 40 of the nanostructures 41. Wherein, the metasurface module 60 and the type of arrangement 40 in single configuration can been seen.

FIGS. 8A-8F illustrate some embodiments of top view of the arrangement 40 of the nanostructures 41 to generate a metasurface array in FIG. 8A single square configuration, FIG. 8B rectangular configuration, FIG. 8C trapezoid configuration, FIG. 8D L-shaped configuration, FIG. 8E square non-overlapping array configuration, and FIG. 8F circular overlapping array. However, the top view of the arrangement 40 of the nanostructures are not limited to these shapes and configurations.

FIG. 9 illustrates a schematic diagram of a DBR-based metasurface module with one spacer layer 433 and m DBRs and without any spacer layer positioned between each two of DBRs.

FIG. 10 illustrates a schematic diagram of a DBR-based metasurface module with one spacer layer 433 and three DBRs without any spacer layer positioned between each two of DBRs.

FIG. 11A illustrates a schematic diagram of a DBR-based metasurface module with one spacer layer 433 and multi-DBRs including the spacer layer Sp positioned between each two of DBRs.

FIG. 11B illustrates a schematic diagram of a DBR-based metasurface module. Another diagram shows the effect on the reflected light of the DBR-based metasurface module applied the different thickness of spacer layer Sp positioned (here p=1) between each two of DBRs.

FIG. 11C illustrates a schematic diagram of a DBR-based metasurface module. Another diagram shows the effect on the reflected light of the DBR-based metasurface module depicting the effect on the reflected light applied the different thickness of spacer layer 433 positioned between the metasurface layer 70 and all DBRs.

FIG. 11D illustrates a schematic diagram of two examples of a DBR-based metasurface module. Another diagram shows the effect on the reflected light of the DBR-based metasurface module depicting the effect on the reflected light when the thickness of DBR changes.

FIG. 11E illustrates two examples of the DBR-based metasurface module with three DBRs and the different pair number of each of three DBRs.

FIG. 11F illustrates a bandwidth created by DBR layer without nanostructures compared to the bandwidth of bands created by the same DBR layer with nanostructures.

FIGS. 12A-12C illustrate examples of band tuning and number of bands in a multi-band scheme, five bands (colors), three bands (colors) and two bands (colors), respectively.

FIGS. 13A-13D illustrate single-band structures nanostructures, (A) with cladding with uniform thickness of spacer layer 43 (B) without cladding with uniform thickness of spacer layer 43, (C) with cladding with at least one layer with non-uniform thickness of spacer layer 433NU (D) without cladding with at least one layer with non-uniform thickness of spacer layer 433NU.

FIG. 14 illustrates an example of band tuning in a single-band scheme according to single-band structures of FIGS. 13A-13D.

FIG. 15 illustrates a thickness of a unit of each layer of the proposed metasurface module can be totally uniform (t₁=t₂=t₃=t₄) or can be utterly non-uniform (t₁≠t₂≠t₃≠t₄), or some can be uniform while the other non-uniform.

FIGS. 16A and 16B illustrates a band and amplitude for single-band (A) and for multi-band (B) of metasurface module.

FIGS. 17A-17E illustrate five examples of nanostructure arrangement with different shapes of nanostructures disposed in the proposed metasurface module. In the example, the shapes of nanostructures can vary from an isotropic shape all the way to an anisotropic shape or combination of isotropic and anisotropic shaped nanostructures or grating.

FIG. 18A illustrates a schematic diagram of the mechanism behind multi-band (or single band) color segregating by the proposed metasurface module with DBRs.

FIG. 18B illustrates a schematic diagram of the proposed metasurface module with DBRs applied to a pair of proposed glasses. Each eye receives different color bands with different polarizations. Where R, g, B, C, M, and Y represent red, green, blue, cyan, magenta, yellow color bands respectively.

FIG. 18C illustrates a schematic diagram of Distributed Bragg reflector (DBR) band tuning using different layers of repeated pairs of high refractive index material layer and low refractive index material layer. Top panel shows a DBR layer with one DBR, middle panel shows a DBR layer with two DBRs, bottom panel shows a DBR layer with three DBRs.

FIG. 18D illustrates a schematic diagram of DBR-based metasurface module for the left eye (top panel) and the right eye (bottom panel).

FIG. 18E illustrates Pancharatnam-Berry (PB) phase profile versus rotation of the nanostructures. As shown all the color bands support phase variation from 0 to 271 and beyond.

FIG. 18F illustrates examples on how increasing “pair number N₁ of the DBR” will affect the bandwidth of the DBR.

FIGS. 19A-19C illustrate three type of glasses for the proposed metasurface module applications, FIG. 19A waveguide, FIG. 19B pancake, aspheric lenses, FIG. 19C free-from. However, not limited to only these applications. It's noted that the proposed metasurface module can be mechanically or electrically rotated and/or tuned.

FIGS. 20A-20D illustrate one application of the proposed metasurface module applied to an optical device. For example, the proposed metasurface modules are designed for the color arrangement and crosstalk of the pair of glasses for right and left eye. Where DOE represents a diffractive optical element, which is the proposed metasurface module in this work.

FIG. 21 illustrates another application of the proposed metasurface module applied to optical detection device, such as orbital angular momentum (OAM) generator or sorter, metalenses, spectroscopy application like Raman spectroscopy and sensing such as time of flight (ToF).

### DETAILED DESCRIPTION

Implementations of the disclosure will now be described, by way of embodiments only, with reference to the drawings. The disclosure is illustrative only, and changes may be made in the detail within the principles of the present disclosure. It will, therefore, be appreciated that the embodiments may be modified within the scope of the claims.

Unless otherwise defined, all technical terms used herein have the same meaning as commonly understood by one of ordinary skill in the art. The technical terms used herein are to provide a thorough understanding of the embodiments described herein but are not to be considered as limiting the scope of the embodiments.

Several definitions that apply throughout this disclosure will now be presented.

The term “coupled” is defined as connected, whether directly or indirectly through intervening components, and is not necessarily limited to physical connections. The term “substantially” is defined to be essentially conforming to the particular dimension, shape or other word that the term modifies, such that the component need not be exact. The term “comprising,” when utilized, means “including, but not necessarily limited to”, it specifically indicates open-ended inclusion or membership in the so-described combination, group, series, and the like.

Human stereoscopic vision can be stimulated by showing two precisely processed images for each eye. When two eyes see images that are akin in all attributes, but for a slight horizontal shift in object position, stereoscopic vision comes to work. However, any additional differences in intensity, color, timing, focus, or object shape introduce an unconscious overload of the visual system. Depending on the degree of this discrepancy, the user may face less immersive 3D experience, leading to discomfort and headaches, or even a complete loss of depth perception. Recently, aside from 3D cinemas applications, stereo-imaging is widely being utilized in smart glasses.

AR/VR/MR glasses are rapidly growing to show users an outstanding image quality unseen on available televisions or smart phones. However, to create a good computed generated 3D object, GPU needs to shoulder a heavy processing which drains the battery quickly and for complex objects it might not be quick enough as demanded in the real-time application. Besides, camera-based capture-and-show 3D image glasses are functional only when the ambient light is enough otherwise the error in creating the 3D image will be unpleasant to user's eyes. Moreover, the cross-polarized, filter wheel, active color filter, dichroic filters, double complimentary channel switching, and complimentary-color stereo glasses for producing a 3D image are prone to eye fatigue due to imperfection of either the polarizers or color filters which leads to a crosstalk and untrue color reproduction. Here, a metasurface module with multi-bands is disclosed, and crosstalk between bands created by the metasurface module can be fully adjusted. In particular, a metasurface module with multi-bands is disclosed, and crosstalk between bands created by the metasurface module can be fully adjusted. Besides, each eye can receive the image content in different polarizations to further ensure that each eye can only see the image that meant for, to minimize the crosstalk.

Once the crosstalk is mitigated, a color matching algorithm in the CIELAB (CIELUV) color space matches the perceptual color traits in particular the hue, rather than mitigating the sum of the distances amid the perceived anaglyph color and the stereo image pair.

The metasurface module 60 of the present disclosure can be applied on different platforms including different displays. The term “display” herein can be laser beam scanner (LBS), micro light-emitting diode (uLED), micro organic light-emitting diode (uOLED), liquid-crystal-on-silicon (LCOS), digital micromirror device (DMD), digital light processer (DLP), micro and Pico projectors; and various combiners (couplers) such as freeform half mirror, birdbath, pancake lens, aspheric lens, freeform prism, holographic optical element (HOE), cascaded mirrors, and grating couplers, surface relief grating (SRG), volume Bragg grating (VBG), polarization volume grating (PVG), holographic polymer dispersed liquid crystal (HPDLC), hybrid curved holographic reflector (HCHR), pin-mirror, partial reflector, half tone reflector, meta-waveguide, metasurface, metalens, or other diffractive elements.

The metasurface module 60 can be also applied in spectroscopy and ToF applications, as it enables a super fine separation of the spectral of the incoming light to as many bands as needed.

Implementations of the disclosure will now be described, by way of embodiments only, with reference to the drawings. The disclosure is illustrative only, and changes may be made in the detail within the principles of the present disclosure. It will, therefore, be appreciated that the embodiments may be modified within the scope of the claims.

Unless otherwise defined, all technical terms used herein have the same meaning as commonly understood by one of ordinary skill in the art. The technical terms used herein are to provide a thorough understanding of the embodiments described herein but are not to be considered as limiting the scope of the embodiment.

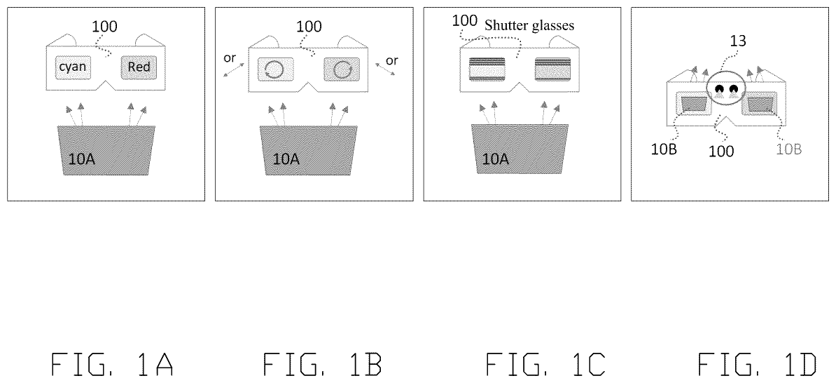

As shown in FIGS. 1A-1D, selected prior arts on 3D imaging were depicted, wherein a display 10A and AR/VR/MR glasses 100 are shown. As shown in FIG. 1A, FIG. 1A illustrates a prior art on 3D imaging using color filter glasses 100 with any complimentary color bands (such as red-cyan, green-purple, yellow-blue). In particular, the complimentary color bands used in FIG. 1A can be cyan and red color band for example. The display 10A projects an image with one complimentary color band (such as cyan color band) to one eye and projects another image with another complimentary color band (such as red color band) to another eye, then forming a 3D imaging to user's brain.

As shown in FIG. 1B, FIG. 1B illustrates a prior art on 3D imaging using cross-polarized glasses, either linear polarizer or circular polarizer. Taking 3D imaging using cross-polarized glasses with circular polarizer (which can be integrated with display 10A) for example, the display 10A projects a circular light to one eye and projects a different circular light to another eye, in order to form a 3D imaging to user's brain. It can be understood that, another embodiment using linear polarizer can be arranged in a similar way as the embodiment using circular polarizer in FIG. 1B.

As shown in FIG. 1C, FIG. 1C illustrates a prior art on 3D imaging using shutter-glasses 100. The display 10A projects lights with different polarizations to each eye, and the shutter-glasses 100 flip between images quicker than the human eye detection rate (frame per second) to deliver an illusion of motion, in order to form a 3D imaging to user's brain.

As shown in FIG. 1D, FIG. 1D illustrates a selected prior art on 3D imaging by capturing the ambient objects (not shown) through the cameras 13 then reconstruct a 3D image out of the objects there and display it to the users via display 10B of AR/VR/MR glasses 100. Wherein, the display 10B can be integrated into AR/VR/MR glasses 100.

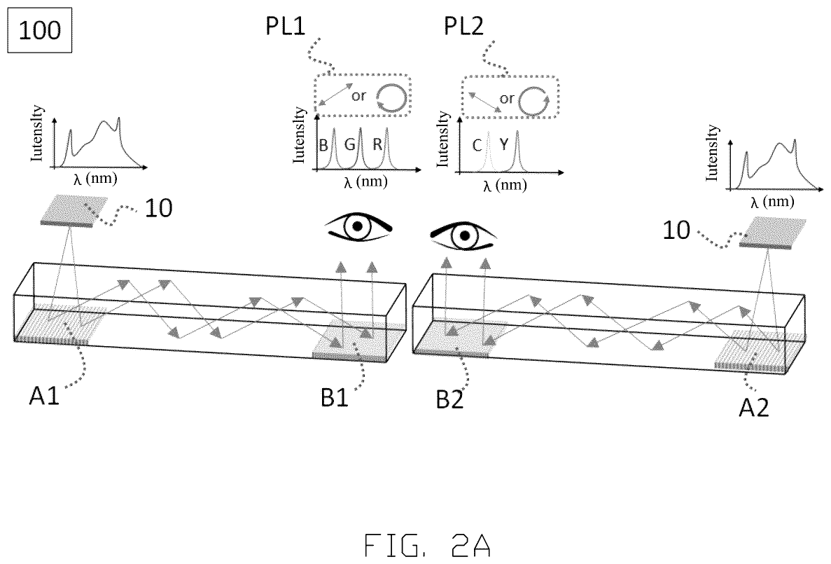

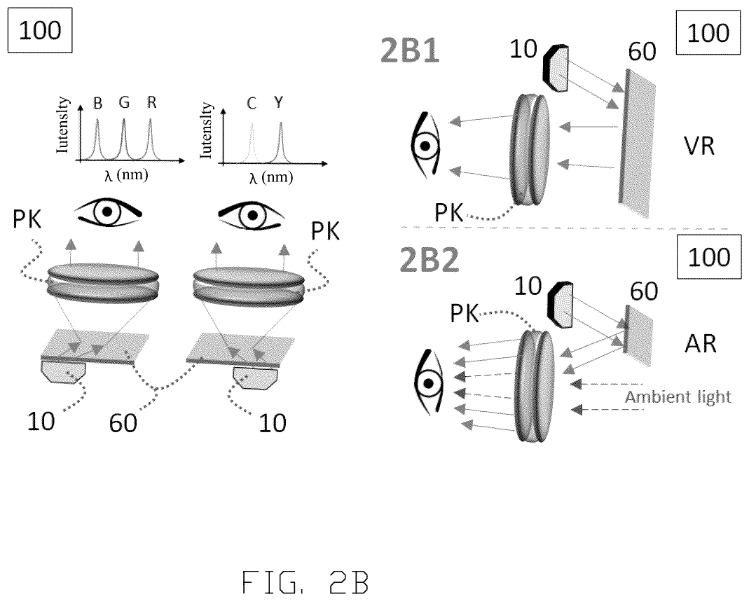

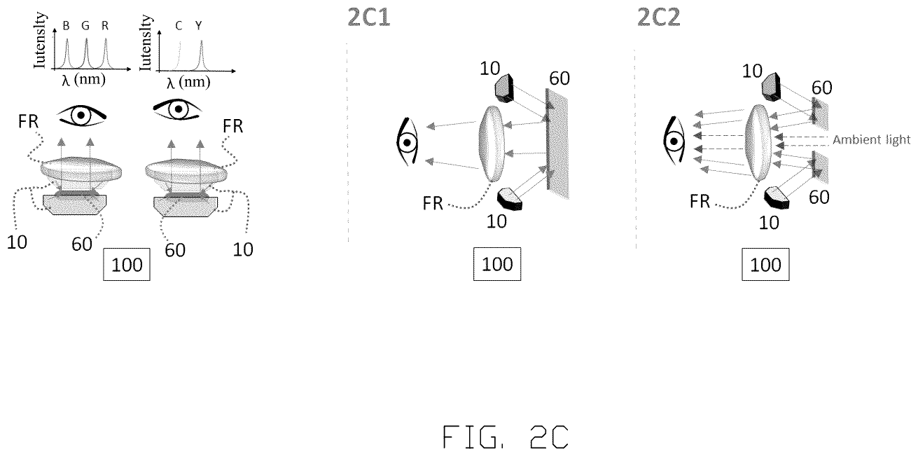

As shown in FIGS. 2A-2C, there is a design including two displays 10. However, there might be another design where there is only one display 10 at the center and with the mean of a beam splitter the image can be sent to both eyes (not shown in FIG. 2A). As shown in FIG. 2A, the part marked by “A1 and A2” can be metasurface alone which enable splitting the colors intro specific bands with designated polarization, the “B1 and B2” part is a coupler which can be made any of SRG, VBG, PVG, HPDLC, HCHR, pin-mirror, partial reflector, half tone reflector, meta-waveguide, metasurface, metalens and other diffractive or non-diffractive elements in order to direct the image contain to the user's eyes. In other embodiments, the part marked by “A1 and A2” can also be the metasurface module 60 which will be described as following. PL1 and PL2 show the outgoing polarized light type of the left and right eye respectively which can be linearly polarized or circularly polarized (it also can be unpolarized). The display 10 can be any of LSB, uLED, uOLED, LCOS, DMD, DLP, micro and pico projectors, however, no only limited to these types.

As shown in FIG. 2B, FIG. 2B illustrates an application of the metasurface module 60 applied to pancake-based glasses 100 according to another embodiment of the present application. The PK represents a pancake lens in figures. In particular, 2B1 and 2B2 in FIG. 2B show the light path for an eye in the embodiment of FIG. 2B. A display 10 (or a light source) emits light towards the metasurface module 60. The metasurface module 60 then reflects the light towards pancake lens PK. Subsequently, the light transmitted through the pancake lens PK enters the eye. The pancake-based glasses 100 can be VR glasses, and the eye will not receive ambient light (see 2B1 in FIG. 2B). The pancake-based glasses 100 can be AR glasses, and the eye will receive ambient light (see 2B2 in FIG. 2B).

As shown in FIG. 2C, FIG. 2C illustrates an application of the metasurface module 60 applied to freeform-based glasses 100 according to a further embodiment of the present application. The freeform-based glasses 100 can use a free-form optical element FR. The free-form optical element FR can be a birdbath. In particular, 2C1 and 2C2 in FIG. 2C show the light path for an eye in the embodiment of FIG. 2C. A display 10 (or a light source) emits light towards the metasurface module 60. The metasurface module 60 then reflects the light towards free-form optical element FR. Subsequently, the light transmitted through the free-form optical element FR enters the eye. The freeform-based glasses 100 can be VR glasses, and the eye will not receive ambient light (see FIG. 2C1). The freeform-based glasses 100 can be AR glasses, and the eye will receive ambient light (see 2C2 in FIG. 2C).

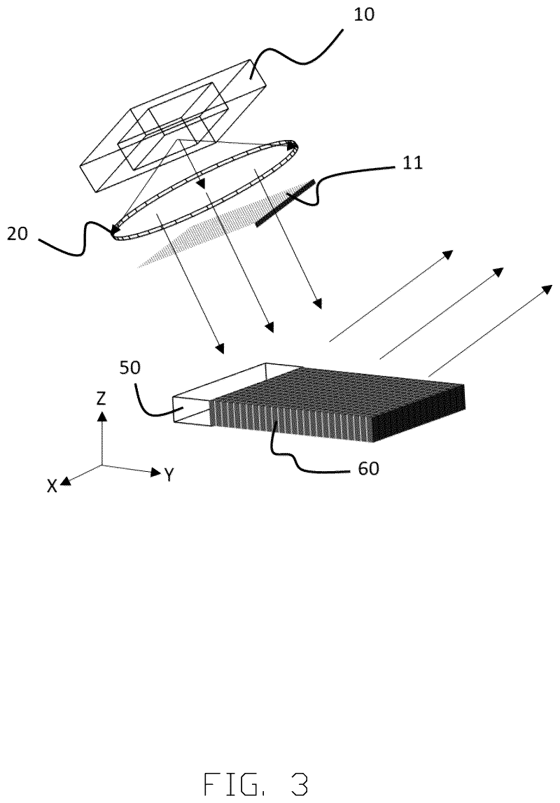

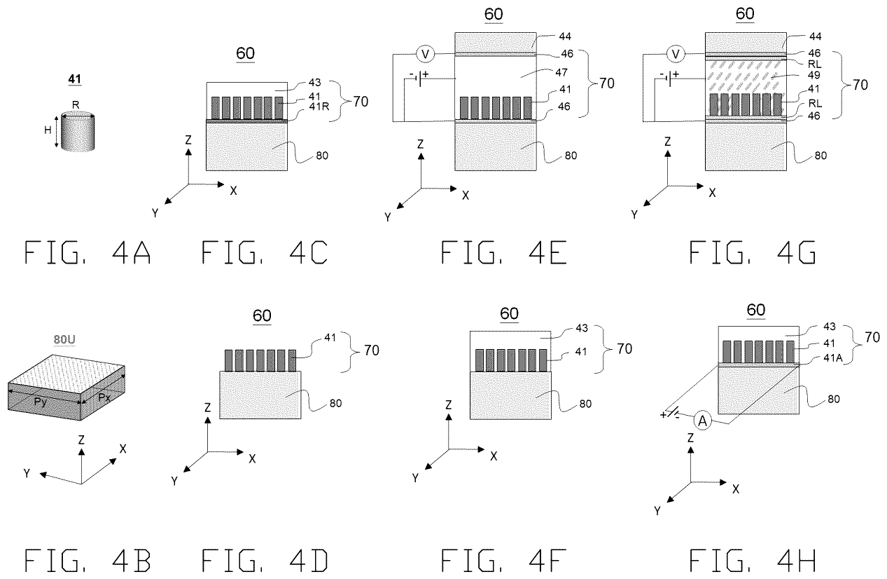

FIG. 3 illustrates a schematic diagram of a VR/AR glasses (not shown) including the metasurface module 60. A display 10, a lens-set 20, a controller 50, and a metasurface module 60 are shown in FIG. 3. The display 10 can be any of LSB, uLED, uOLED, LCOS, DMD, DLP, micro and pico projectors, however, no only limited to these types. The display 10 projects the image and the lens-set 20 is collimating the light and pass it through an optional polarizer 11 (e.g., a linear polarizer or a circular polarizer, depends on the design of the nanostructures whether they are polarizer dependent or polarizer independent) then the light will arrive to the surface of the metasurface module 60 which is equipped with controller 50. The controller 50 is configured for electrically or mechanically controlling the metasurface module 60. In some embodiments, the controller 50 is configured for electrically controlling the metasurface module 60 when an active metasurface module is used (such as active metasurface modules 60 shown in FIGS. 4E-4F). In other embodiments, the controller 50 is configured for mechanically controlling the metasurface module 60 by rotating or moving the metasurface module 60 along X, Y, or Z axis or align display contents for calibration. Once the light beam is modulated by the metasurface module 60, it can be shown to the user's eyes via other optical elements such as light guides, pancake lens(es), aspheric lens(es), birdbath optics, diffractive optical elements and so on.

FIGS. 4A-4H illustrate examples of a nanostructure 41, a unit of DBR layer 80U, and a metasurface module 60 with passive and active type.

FIG. 4A shows an example of a cylindrical nanostructure 41 with radius of R and height of H. The radius R can vary from 20 nm to 550 nm. If the desire spectrum is visible (or near-infrared or infrared), H can have a value of 20 nm to 3000 nm.

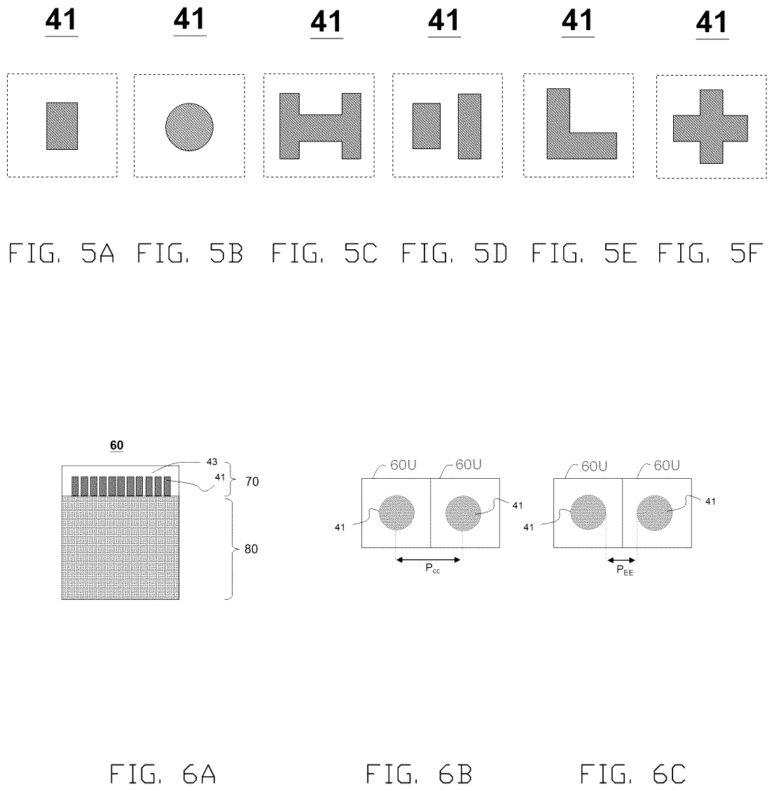

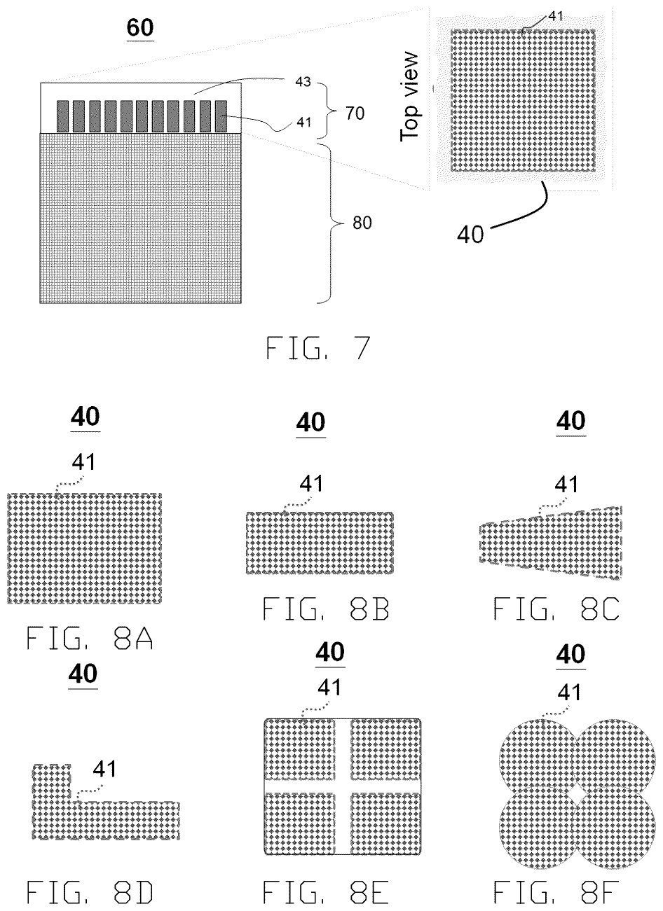

It worth mentioning that, the working range of the metasurface module (such as the metasurface module 60 shown in FIGS. 4C-4H, 9-11A, 13A-13D, and 18A-18F) or metasurface layer (such as the metasurface layer 70 shown in FIGS. 4C-4H, 9-11A, 13A-13D, and 18A-18F) composed of a plurality of nanostructures 41 is scalable. In addition, if the nanostructures 41 shown in FIGS. 4C-4H, 9-11A, 13A-13D, and 18A-18F are properly designed, the metasurface module (such as the metasurface module 60 shown in FIGS. 4C-4H, 9-11A, 13A-13D, and 18A-18F) composed of a plurality of nanostructures 41 can work at different wavelengths. In one embodiment, the nanostructure 41 can have an isotropic or anisotropic shape like the examples in FIGS. 5A-5F. In some embodiments, the materials of nanostructure 41 are composed of dielectric (TiO₂, GaN, Si, Nb₂O₅, SiO₂, SiC photoresist, metal oxide nanoparticles (ZrO₂, TiO₂) and sol-gel mixture, etc.), or metal (like gold, silver, aluminum, etc.) or other active materials (2D materials, VO₂, GST, metallic polymers) or metallic polymer such as PEDOT: PSS (poly(3,4-ethylenedioxythiophene): poly(-styrene sulfonate) or any conducting polymers, however, not only limited to these materials. Moreover, the plurality of nanostructures 41 can turn to an active and focus/deflection-adjustable metasurface layer (see metasurface layer 70 shown in FIGS. 6A, and 7) utilizing any phase changing materials like GST (Ge₂Sb₂Te₅), vanadium dioxide (VO₂), and gallium (Ga) and other active materials such as transparent conducting oxides (like ITO and AZO), thin 2D materials (graphene, hBN, and WS₂), liquid crystal, metallic polymer, and so on. Therefore, a programmable metasurface layer (see metasurface layer 70 shown in FIGS. 6A and 7) is achievable to thoroughly or locally changing the light modulation. Moreover, the nanostructures 41 can be fabricated using different methods such as Electron-beam lithography (EBL), Deep Ultraviolet (DUV) Photolithography, Extreme ultraviolet lithography (EUV), Nanoimprint lithography (NIL), and direct Nanoimprint using mixture of metal oxide nanoparticles and sol-gel.

FIG. 4B shows an example of a unit of DBR layer 80U. A plurality of units of DBR layer 80U can generate the DBR layer 80 of the metasurface module 60 (as shown in FIGS. 6A and 7).

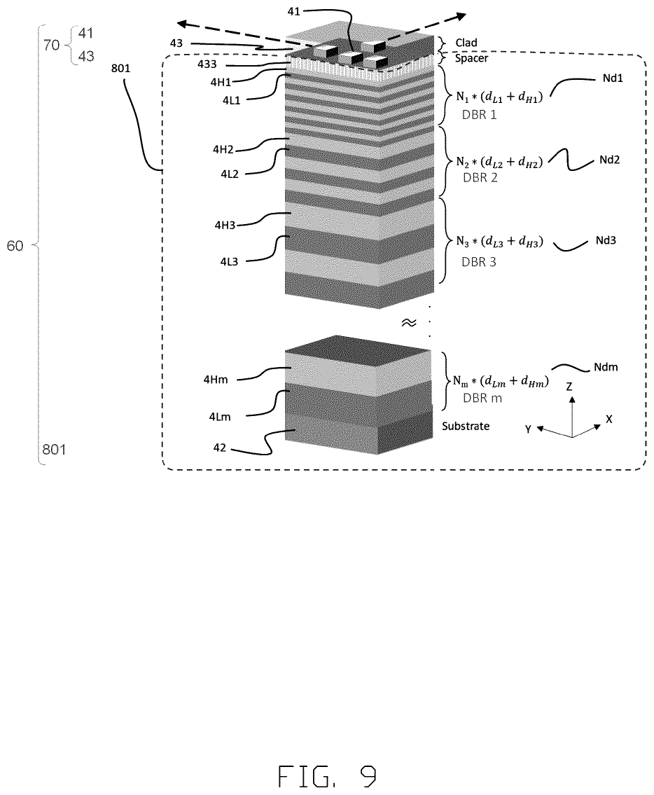

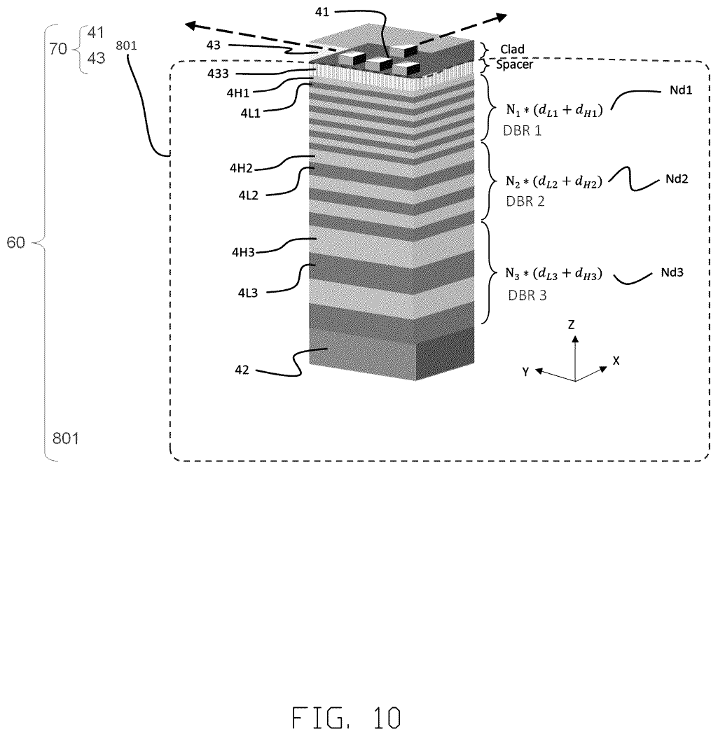

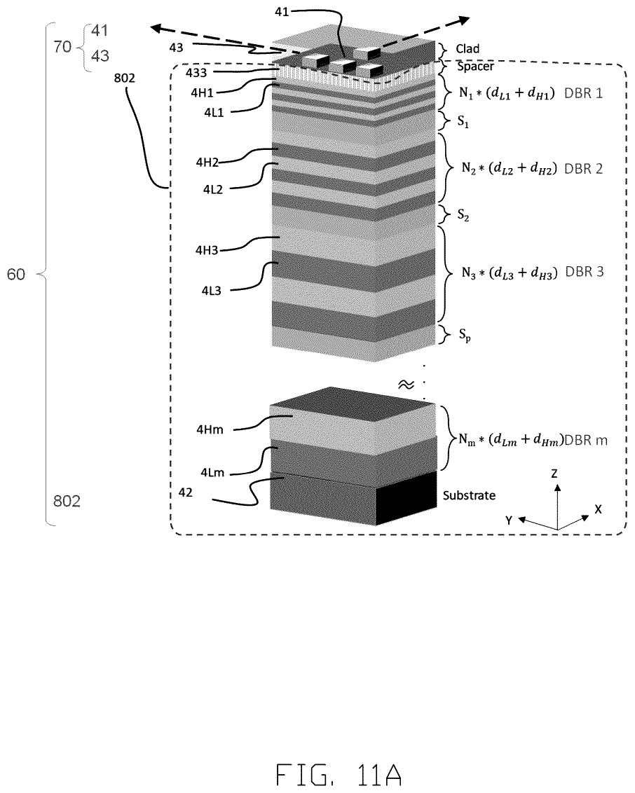

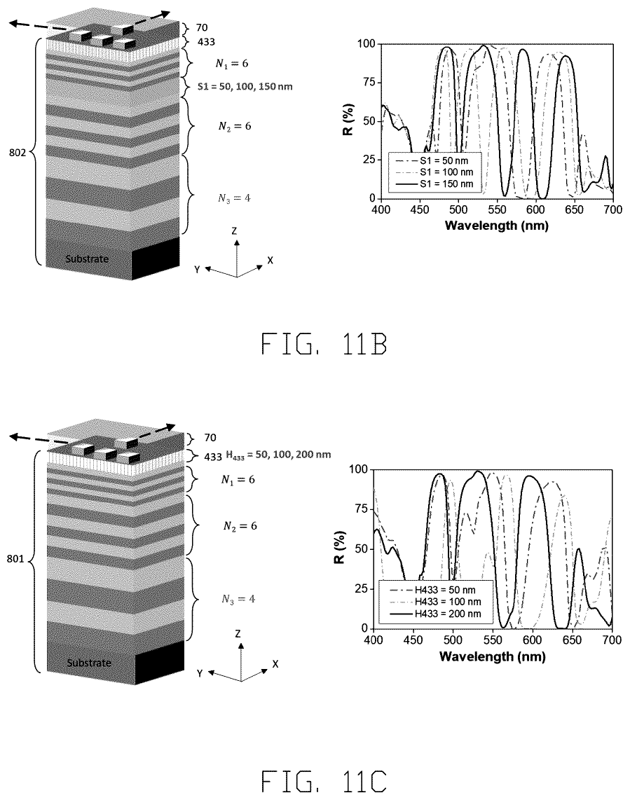

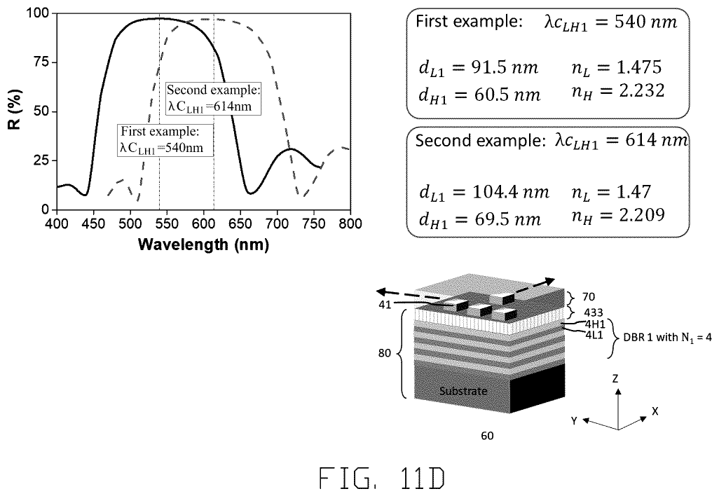

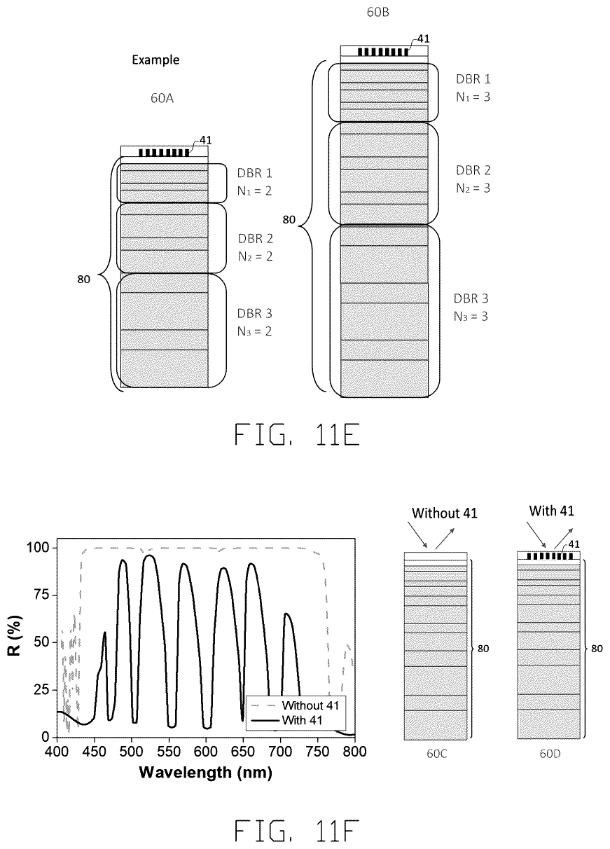

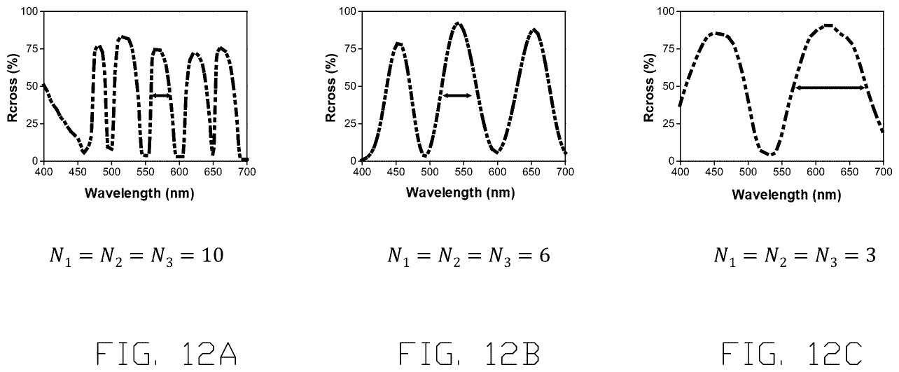

The pitch of unit of the DBR layer 80U is along x-axis and y-axis are defined Px and Py respectively. The definition of the pitch is further explained in examples of FIG. 6B and FIG. 6C. The substrate 42 as shown in FIG. 9, FIG. 10, FIG. 11A can be any type of transparent/non-transparent substrate, such as fused silica (SiO₂), Sapphire (Al₂O₃), Silicon Carbide (SiC), and silicon and other materials if necessary.

FIG. 4C illustrates one embodiment of a passive metasurface module 60. The metasurface module 60 can include one metasurface layer 70 and one DBR layer 80. In one embodiment, the metasurface layer 70 can have nanostructures 41, a residual resin mixture 41R and a cladding layer 43. Each of the nanostructures 41 can have a dimension of radius R, height H as shown in FIG. 4A. In this embodiment, a plurality of directly nanoimprinted nanostructures 41 can be disposed on the top of the DBR layer 80. The directly nanoimprinted nanostructures 41 can be made of high refractive index resin or metal oxide nanoparticles, as well as a sol-gel mixture such as TiO₂, ZrO₂, and ITO with sol-gel. The residual resin mixture 41R is shown between the directly nanoimprinted nanostructures 41 and the DBR layer 80 after direct nanoimprint. The cladding layer 43 is shown as an impedance matching layer, or a part of waveguide or any complimentary optical element.

FIG. 4D illustrates another embodiment of a passive metasurface module 60 without cladding layer 43. FIG. 4D shows that the passive metasurface module 60 can include one metasurface layer 70 and one DBR layer 80. As shown in FIG. 4D, the metasurface layer 70 can have nanostructures 41 without a cladding layer 43 (as shown in FIG. 4C). The nanostructures 41 can be made of materials as explained in above description of FIG. 4A. The plurality of nanostructures 41 can be made from materials (such as dielectric like curable resin, photoresist, and metal oxide nanoparticles and sol-gel mixture, etc.) of different thicknesses ranging from 150 nm to a few thousand nanometers for nano pillars and thin deposition of metal oxides (TiO₂, Al₂O₃, HfO₂), or metal (like gold, silver, aluminum, etc.) from 10 nm to 70 nm. However, thicknesses of nano pillars and thin deposition of metal oxides or metal are not limited only to above mentioned ranges. In this embodiment, the nanostructures 41 can be disposed on the top of one DBR layer 80. In particular, the nanostructures 41 can be directedly disposed on the top of one DBR layer 80.

FIG. 4E demonstrates an embodiment of an active metasurface module 60. The active metasurface module 60 can include one metasurface layer 70, one DBR layer 80 and one glass layer 44. The metasurface layer 70 can have nanostructures 41, two transparent electrodes 46 and a filled material 47. The nanostructures 41 are sandwiched between the glass layer 44 and the DBR layer 80. The glass layer 44 can be transparent or non-transparent. In one embodiment, a transparent electrode 46 can be deposited on one side of the glass layer 44. In addition, the other transparent electrode 46 can be deposited on the DBR layer 80. The transparent electrode 46 can be such as indium tin oxide (ITO). Then, the space (not shown) between the two transparent electrodes 46 is filled by filled material 47. In some embodiments, the filled material 47 may be an electrolyte or a gel electrolyte, to enable the active metasurface module 60 as an active type. In some embodiments, the filled material 47 can be sandwiched between the two transparent electrodes 46 and surround the nanostructures 41.

FIG. 4F shows another embodiment of an active metasurface module 60. The active metasurface module 60 can include one metasurface layer 70 and one DBR layer 80. The metasurface layer 70 can have nanostructures 41 and a cladding layer 43. The only difference between FIG. 4F and FIG. 4C is that the nanostructures 41 of FIG. 4F are made of active materials like VO₂ and 2D materials earlier mentioned and the residual resin mixture 41R is not shown in FIG. 4F after direct nanoimprint. The cladding layer 43 is shown as an impedance matching layer, or a part of waveguide or any complimentary optical element.

FIG. 4G illustrates further embodiment of a liquid crystal-based active metasurface module 60. The active metasurface module 60 can include one metasurface layer 70, one DBR layer 80 and one glass layer 44. The metasurface layer 70 can have nanostructures 41, two transparent electrodes 46 and liquid crystal 49 filled in a space (not shown) between the two transparent electrodes 46. The nanostructures 41 are sandwiched between the glass layer 44 and the DBR layer 80 with deposited transparent electrode 46 on it. The glass layer 44 can be transparent or non-transparent. The transparent electrodes 46 can be such as indium tin oxide (ITO). The alignment layer RL is either mechanically rubbed (or is produced via photoalignment) usually made of polyimide or other organic compound such as Azo dye molecules rubbed on the transparent electrode 46. The nanostructures 41 can be dielectric or metal (or any earlier mentioned materials). The space (not shown) between the two transparent electrodes 46 is filled with liquid crystal 49 either with uniform thickness or non-uniform thickness. The liquid crystal 49 can work in two ways. As shown in FIG. 4G, one approach is that the liquid crystal 49 can act as the ambient refractive index changing material. The resonance of the nanostructures 41 are very sensitive to the ambient refractive index, therefore if the nanostructures 41 are carefully designed, it can tune the output light at will. As shown in FIG. 4G, the second approach is that if the top transparent electrode 46 (the one attached to top glass layer 44) is photolithographically patterned, the liquid crystal 49 can act as a compensating and correcting layer for nanostructures 41. For instance, like concentric rings to form a lens or like bars to focus the light.

FIG. 4H illustrates further another embodiment of a phase changing material-based active metasurface module 60. The nanostructures 41 can be made of a phase changing material such as GST (Ge₂Sb₂Te₅), vanadium dioxide (VO₂), and gallium (Ga) but not limited to these three materials which mostly work based on a resistive heating film 41A. The cladding layer 43 is made of photoresist, resin or any material which matches the refractive index with the complimentary optical element supposed to work with. For example, in case if the proposed metasurface module 60 needs to be used in a waveguide, the cladding layer 43 should have a material with a refractive index compatible with the waveguide glass/plastic slab.

As shown in FIGS. 5A-5F, each of the plurality of the nanostructures 41 could be formed in different isotropic, anisotropic, or combination of isotropic and anisotropic shapes. There can be one single nanostructure in one unit of metasurface module (see FIGS. 5A-5C, and FIGS. 5E-5F) or multi-nanostructures in one unit of metasurface module (see FIG. 5D). Each of the plurality of the nanostructures 41 in one unit of metasurface module can be substantially rectangular (see FIG. 5A), circular (see FIG. 5B), H-shaped (see FIG. 5C), L-shaped from (see FIG. 5E), and cross-like from (see FIG. 5F) respectively from the top view. Optionally, multi-nanostructures 41 can be separately formed in one unit of metasurface module (see FIG. 5D). It can be understood that, a plurality of units of metasurface module can generate a metasurface module.

FIG. 6A illustrates an embodiment of a metasurface module 60 including a plurality of the nanostructures 41, a cladding layer 43 and a DBR layer 80. FIGS. 6B-6C illustrate two types of pitch definition, either center-to-center (Pcc) of two adjacent nanostructures 41 or edge-to-edge (P_{EE}) of two adjacent nanostructures 41. FIG. 6A shows a metasurface module 60 including nanostructures 41, the DBR layers 80, the cladding layer 43. FIG. 6B shows center-to-center pitch (Pcc) of two adjacent nanostructures 41 in each two adjacent units of metasurface module 60U. FIG. 6C shows edge-to-edge pitch (P_{EE}) of two adjacent nanostructures 41 applied in each two adjacent units of metasurface module. Wherein, the metasurface module 60 can be composed by multiple units of metasurface module.

FIG. 7 illustrates a schematic diagram of a DBR-based metasurface module 60 with multi-DBRs and top view of a single arrangement 40 of the nanostructures 41. The metasurface module 60 of FIG. 7 comprises nanostructures 41, a DBR layer 80, a cladding layer 43, as described in FIG. 6A. The only difference is that top view of a single arrangement 40 of the nanostructures 41 can be seen in FIG. 7. The metasurface module 60 and the type of arrangement 40 in single configuration can been seen in FIGS. 8A-8F.

FIGS. 8A-8F show top views of the arrangements 40 of the nanostructures 41 in single square configuration (see FIG. 8A), rectangular configuration (see FIG. 8B), trapezoid configuration (see FIG. 8C), L-shaped configuration (see FIG. 8D), square non-overlapping array configuration (see FIG. 8E), and circular overlapping array (see FIG. 8F). Therefore, the nanostructures 41 can be in a single form or an array form of regular or irregular configuration either single layer or multi-layer.

It can be understood that, the DBR layer 80 (shown in FIGS. 4B-4H, 6A-7) can be a DBR layer 801 shown in FIGS. 9-10 or a DBR layer 802 shown in FIG. 11A. The difference between the DBR layer 801 and the DBR layer 802 is that the DBR layer 802 further comprises at least one spacer layer (Sp, shown in FIG. 11A) positioned between each two of DBRs, compared to the DBR layer 801.

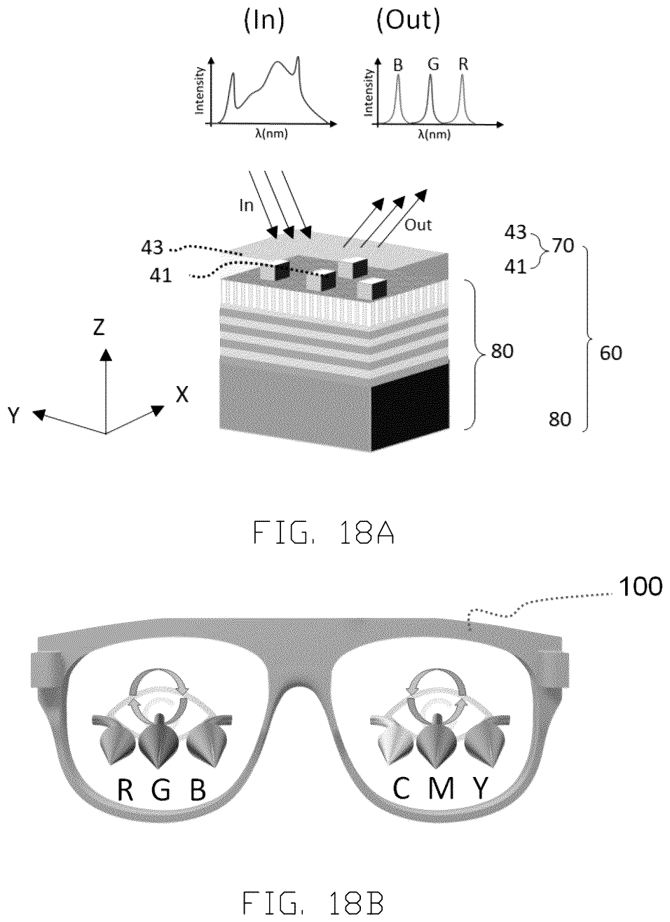

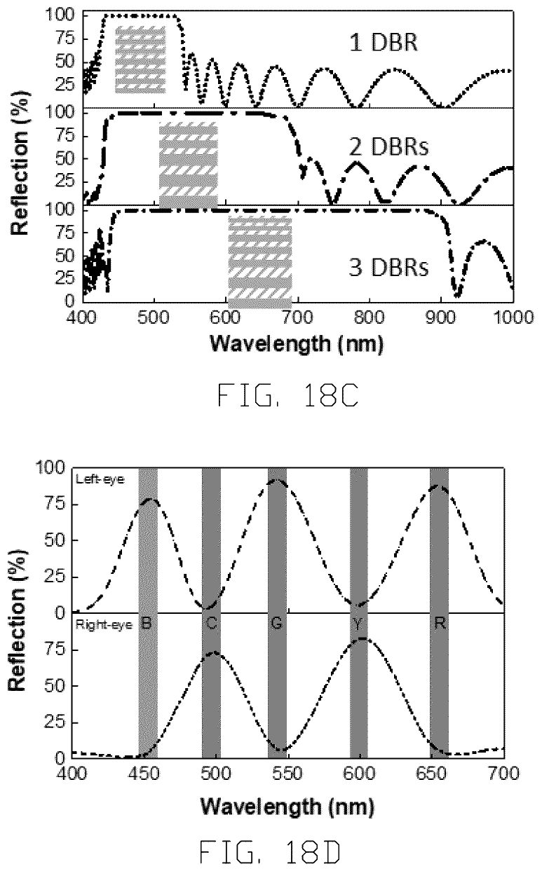

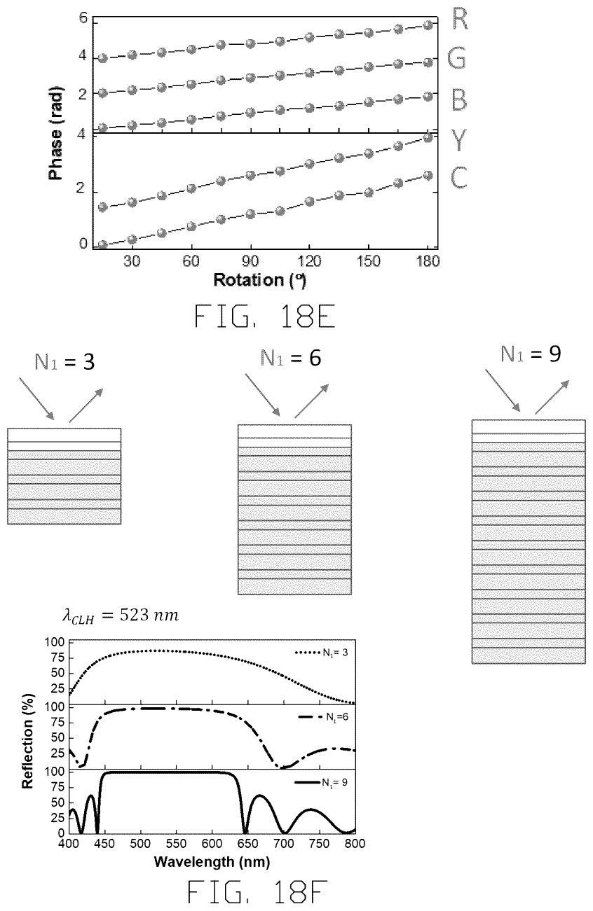

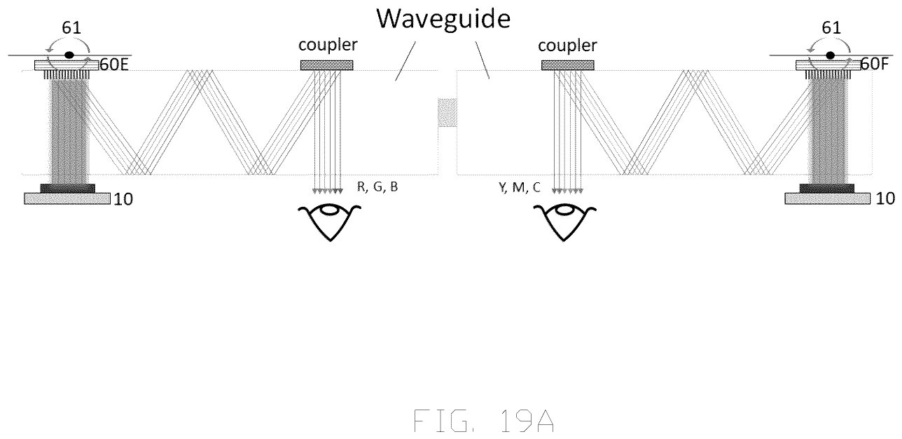

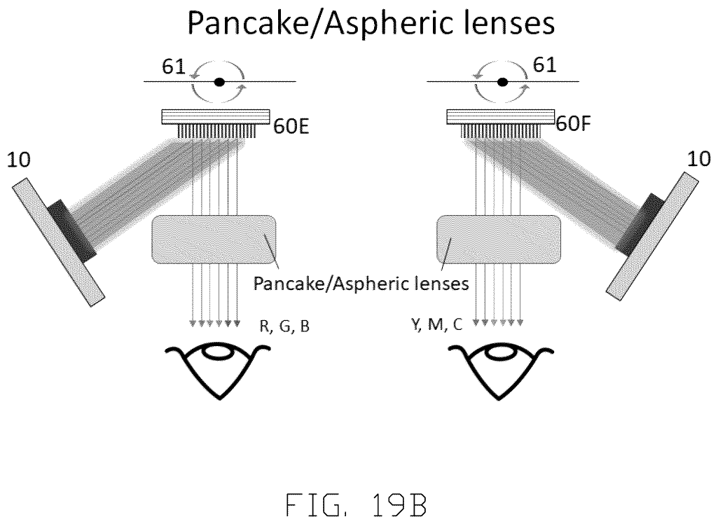

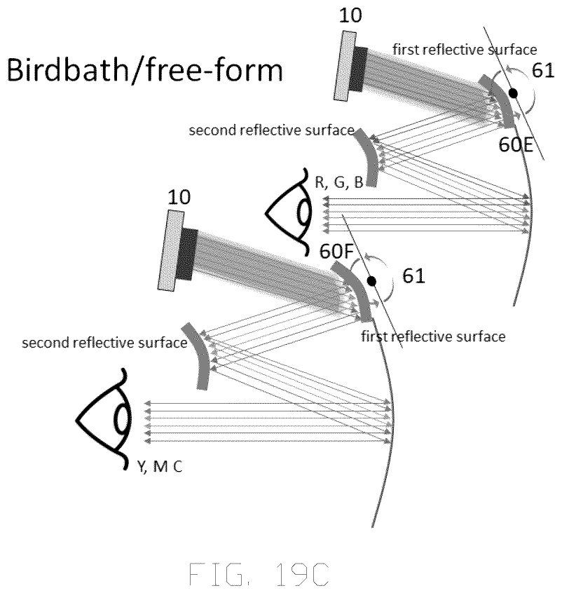

FIG. 9 illustrates a schematic diagram of a metasurface module 60 with multi-DBRs without any spacer layer (not shown, such as spacer layer Sp shown in FIG. 11A) positioned between each two of DBRs. The DBR-based metasurface module 60 comprises at least a metasurface layer 70 and a DBR layer 801, and the metasurface layer 70 comprises nanostructures 41 and a cladding layer 43. The cladding layer 43 can be regarded as an impedance matching layer or as a part of other complimentary optical elements like a waveguide slab or it can be even air. Preliminary results exhibit that a broad reflection window (broad band-pass filter) can be realized from a DBR layer 80 with a few DBR as shown in FIG. 18C. Two alternating layers (i.e., high refractive index material layer and low refractive index material layer) with quarter-wave thicknesses which fulfill the condition n_{L}d_{Lm}=n_{H}d_{Hm}=λc_{LHm}/4, where λc_{LHm} (not shown) is the central wavelength. n_{L} is a low refractive index of the low refractive material layer 4Lm. n_{H} is a high refractive index of the high refractive material layer 4Hm. d_{Lm} is a thickness of each low refractive index material layer 4Lm for the mth DBR. d_{Hm} is a thickness of each high refractive index material layer 4Hm for the mth DBR. As shown in FIG. 9, the DBR layer 801 comprises a plurality of DBRs, and the number of the DBRs is m. The mth DBR is composed by at least one pair of high refractive index material layer 4Hm and low refractive index material layer 4Lm respectively. That is, each of the DBR is composed by at least one pair of high refractive index material layer and low refractive index material layer. Nm represents pair number of mth DBR. N₁=6 indicates that the 1st DBR (DBR 1) has 6 times pair-repetition of high refractive index material layer 4H1 and low refractive index material layer 4L1. N₂=3 indicates that the 2nd DBR (DBR 2) has 3 times pair-repetition of high refractive index material layer 4H2 and low refractive index material layer 4L2. N₃=2 indicates that the 3rd DBR (DBR 3) has 2 times pair-repetition of high refractive index material layer 4H3 and low refractive index material layer 4L3. N_{dm} indicates that a thickness of the mth DBR. That is N_{dm}=N₁*(d_{Lm}+d_{Hm}). For example, Ndl=N₁*(d_{L1}+d_{H1}), N_{d2}=N₂*(d_{L2}+d_{H2}), N₃=N₃*(d_{L3}+d_{H3}), n_{L} as low refractive index and n_{H} as high refractive index can be the same for all the DBRs or they can be different. The low refractive index material layer 4Lm can be made of such as SiO₂, ZnS, and Al₂O₃ and high refractive index material layer 4Hm can be made of such as Al₂O₃, HFO₂, Ta₂O₅, amorphous Silicon (a-Si), and Transparent Conducting Oxides (TCOs), InGaZnO₄, ZnO, and ZnO:Al but not limited to these materials. The higher refractive index difference between a pair of high refractive index material layer 4Hm and low refractive index material layer 4Lm in a DBR leads to a broader reflection window. The spacer layer 433 can be made of materials like SiO₂, SnO₂, HF₂ and so on. Pair number of each DBR from N₁ to Nm can be equal or different. The substrate 42 can be made of SiO₂, silicon, and other materials. The ordinary order of the pair is low refractive index material layer 4Lm then high refractive index material layer 4Hm. However, in some embodiments, the order might be reversed or even irregular. The DBR layer 801 includes all the DBRs (DBR 1 to DBR m). Generally, the metasurface module 60 further comprises a spacer layer 433 disposed under the plurality of nanostructures 41 and a substrate 42 at the bottom. In one embodiment, the spacer layer 433 and the substrate 42 may be comprised in the DBR layer 801 as shown in FIG. 9. In another embodiment, the spacer layer 433 and the substrate 42 may be excluded from the DBR layer 801 (not shown). Wherein, the spacer layer 433 is sandwiched between the nanostructure 41 and all the DBRs, and all the DBRs are sandwiched between the spacer layer 433 and the substrate 42. The spacer layer 433 is configured to control the Fabry-Perot resonance.

FIG. 10 illustrates a schematic diagram of a DBR-based metasurface module 60 with three DBRs without any spacer layer (not shown, such as spacer layer Sp shown in FIG. 11A) between each two of DBRs. The DBR-based metasurface module 60 comprises at least a metasurface layer 70 and a DBR layer 801, and the metasurface layer 70 comprises nanostructures 41 and a cladding layer 43. The cladding layer 43 can be regarded as an impedance matching layer or as a part of other complimentary optical elements like a waveguide slab or it can be even air. The DBR layer 801 of FIG. 10 comprises three DBRs, each of DBRs is composed by at least one of high refractive index material layer and low refractive index material layer. For 1st DBR (DBR 1), N₁ represents the pair number of 1st DBR. n_{L}d_{L1}=n_{H}d_{H1}=λ_{cLH1}/4, where λ_{cLH1} (not shown) is the central wavelength. d_{L1} is a thickness of each low refractive index material layer 4L1 for the 1st DBR (DBR 1). d_{H1} is a thickness of each high refractive index material layer 4H1 for the 1st DBR (DBR 1). N₁ represents pair number of 1st DBR (N₁=6 for DBR 1 shown in FIG. 10). N_{d1} indicates that a thickness of 1st DBR (N_{d1}=N₁*(d_{L1}+d_{H1})). n_{L}d_{L2}=n_{H}d_{H2}=λ_{cLH2}/4, where λ_{cLH2} (not shown) is the central wavelength. d_{L2} is a thickness of each low refractive index material layer 4L2 for the 2nd DBR (DBR 2). d_{H2} is a thickness of each high refractive index material layer 4H2 for the 2nd DBR (DBR 2). N₂ represents pair number of 2nd DBR (N₂=3 for DBR 2 shown in FIG. 10). N_{d2} indicates that a thickness of 2nd DBR (N_{d2}=N₂*(d_{L2}+d_{H2})). n_{L}d_{L3}=n_{H}d_{H3}=λ_{cLH3}/4, where λ_{cLH3} (not shown) is the central wavelength. d_{L3} is a thickness of each low refractive index material layer 4L3 for the 3rd DBR (DBR 3). d_{H3} is a thickness of each high refractive index material layer 4H3 for the 3rd DBR (DBR 3). N₃ represents pair number of 3rd DBR (N₃=2 for DBR 3 shown in FIG. 10). N_{d3} indicates that a thickness of 3rd DBR (N_{d3}=N₃*(d_{L3}+d_{H3})). Pair number of each DBR from N₁ to N₃ can be equal or different. The low refractive index material layer can be made of such as SiO₂, ZnS, and Al₂O₃. The high refractive index material layer can be made of such as HFO₂, Ta₂O₅, Al₂O₃, amorphous Silicon (a-Si), and Transparent Conducting Oxides (TCOs), InGaZnO₄, ZnO, and ZnO:Al but not limited to these materials. The spacer layer 433 can be made of oxide materials such as SiO₂, SnO₂, HF₂ and so on. The substrate 42 can be made of SiO₂, silicon, and other materials. The DBR layer 801 of FIG. 10 shows all the DBRs (DBR 1-3) below the nanostructures 41. The metasurface module further comprises a spacer layer 433 disposed under the plurality of nanostructures 41 and a substrate 42 at the bottom. In one embodiment, the spacer layer 433 and the substrate 42 may be comprised in the DBR layer 801 as shown in FIG. 10. In another embodiment, the spacer layer 433 and the substrate 42 may be excluded from the DBR layer 801 (not shown). The spacer layer 433 of FIG. 10 generally tunes the resonance for instance to control the Fabry-Perot resonance. Wherein, the spacer layer 433 is sandwiched between the nanostructures 41 and all the DBRs, and all the DBRs are sandwiched between the spacer layer 433 and substrate 42. The spacer layer 433 is configured to control the Fabry-Perot resonance.

FIG. 11A illustrates a schematic diagram of a DBR-based metasurface module 60 with multi-DBRs and at least one spacer layer Sp between each two of DBRs. The DBR-based metasurface module 60 comprises at least a metasurface layer 70 and a DBR layer 802, and the metasurface layer 70 comprises nanostructures 41 and a cladding layer 43. It can be understood that, the difference between the DBR layer 802 as exhibited in FIG. 11A and the DBR layer 801 as exhibited in FIGS. 9-10 is that the DBR layer 802 further comprises at least one spacer layer Sp between each two of DBRs. The cladding layer 43 can be regarded as an impedance matching layer or as a part of other complimentary optical elements like a waveguide slab or it can be even air. Preliminary results exhibit that a broad reflection window (broad bandpass filter) can be realized from a DBR layer with a few DBRs in FIG. 18C. Two alternating layers (i.e., high refractive index material layer 4Hm and low refractive index material layer 4Lm) with quarter-wave thicknesses which fulfill the condition n_{L}d_{Lm}=n_{H}d_{Hm}=λ_{cLHm}/4, where λ_{cLHm} (not shown) is the central wavelength, can enable reflecting the electromagnetic wave efficiently. For example, as shown in FIG. 11A, the DBR layer 802 comprises a plurality of DBRs, and the number of the DBRs is m. The mth DBR is composed by at least one pair of high refractive index material layer 4Hm and low refractive index material layer 4Lm respectively. That is, each of the DBR is composed by at least one pair of high refractive index material layer and low refractive index material layer. Nₘ represents the number of pair-repetition of mth DBR. N₁=3 indicates that the 1st DBR (DBR 1) has 3 times pair-repetition of high refractive index material layer 4H1 and low refractive index material layer 4L1. N₂=3 indicates that the 2nd DBR (DBR 2) has 3 times pair-repetition of high refractive index material layer 4H2 and low refractive index material layer 4L2. N₃=2 indicates that the 3rd DBR (DBR 3) has 2 times pair-repetition of high refractive index material layer 4H3 and low refractive index material layer 4L3. d_{Lm} is a thickness of each low refractive index material layer 4Lm for the mth DBR. d_{Hm} is a thickness of each high refractive index material layer 4Hm for the mth DBR. n_{L} as low refractive index and n_{H} as high refractive index can be the same for all the pairs of high refractive index material layer and low refractive index material layer in each DBR or they can be different. The low refractive index material layer can be made of such as SiO₂, ZnS, and Al₂O₃ and high refractive index material can be made of such as HFO₂, Ta₂O₅, Al₂O₃, amorphous Silicon (a-Si), and Transparent Conducting Oxides (TCOs), InGaZnO₄, ZnO, and ZnO:Al but not limited to these materials. The higher refractive index difference between a pair of high refractive index material layer and low refractive index material layer in a DBR leads to a broader reflection window. Spacer layer Sp between each two of DBRs is configured to tone the resonance which can be made of either low refractive index material layer or high refractive index material layer as mentioned above (see FIG. 11B). As the thickness of spacer layer Sp (such as spacer layer Si shown in FIG. 11B) increases, the resonance peak shifts toward longer wavelengths. Referring back to FIG. 11A, the spacer layer 433 can be made of materials like SiO₂, SnO₂, HF₂ and so on. The pair number in each DBR from N₁ to Nₘ can be equal or different. The substrate 42 can be made of SiO₂, silicon, and other materials. The DBR layer 802 shows all the DBRs (DBR 1 to DBR m) below the nanostructure 41. Generally, the metasurface module further comprises the spacer layer 433, all spacer layers Sp between each two of DBRs, and the substrate 42. In one embodiment, the spacer layer 433, all spacer layers Sp between each two of DBRs, and the substrate 42 may be comprised in the DBR layer 802 as shown in FIG. 11A. In another embodiment, the spacer layer 433, all spacer layers Sp between each two of DBRs, and the substrate 42 may be excluded from the DBR layer 802 (not shown). The spacer layer 433 is configured to control the Fabry-Perot resonance. As the thickness of spacer layer 433 increases, the resonance peak feature alters, as shown in FIG. 11C.

In some embodiments, the metasurface module 60 can comprise the metasurface layer 70 and the DBR layer 80. Wherein, the metasurface layer 70 comprises nanostructures 41 and the cladding layer 43. The DBR layer 80 can be the DBR layer 801 as shown in FIGS. 9-10 or the DBR layer 802 as shown in FIG. 11A. The metasurface module 60 of the embodiment having DBR layer 801 further includes the spacer layer 433 and the DBR layer 801 includes at least one DBR. The difference between the embodiment having DBR layer 801 and the embodiment having DBR layer 802 is that the metasurface module 60 having DBR layer 802 further includes spacer layer Sp positioned between two of DBRs. In particular, the number of the DBR layer 80 in the metasurface module 60 is only one, and the metasurface layer 70 has a first surface and a second surface opposite to the first surface. The first surface of the metasurface layer 70 faces the only one DBR layer 80, and the second surface of the metasurface layer 70 does not face another DBR layer 80. That is, the metasurface module 60 does not have two DBR layer 80 with a metasurface layer 70 sandwiched between the two DBR layer 80. Instead, the metasurface module 60 has only one DBR layer 80, and only one surface of the metasurface layer 70 faces the DBR layer 80.

As described in FIGS. 9-11A, two alternating layers (i.e., low refractive index material layer and high refractive index material layer) with quarter-wave thicknesses fulfill the condition n_{L}d_{Lm}=n_{H}d_{Hm}=λ_{cLHm}/4, where λ_{cLHm} (not shown) is the central wavelength. Nₘ represents pair number of mth DBR. d_{Lm} is a thickness of each low refractive index material layer 4Lm for the mth DBR. d_{Hm} is a thickness of each high refractive index material layer 4Hm for the mth DBR. n_{L} as low refractive index and n_{H} as high refractive index can be the same for all the DBRs or they can be different. That is, if the thickness (d_{Lm}=λ_{cLHm}/4n_{L}; d_{Hm}=λ_{cLHm}/4n_{H}) of low refractive index material layer and high refractive index material layer of a DBR is changed, a new central wavelength is obtained to create the bandpass filter at different spectra. The thickness of low refractive index material layer and high refractive index material layer of a DBR can shift the bandpass filter bandwidth to shorter or longer wavelength centered at λ_{cLHm}. In particular, as the thickness of low refractive index material layer and high refractive index material layer of a DBR increase, a longer central wavelength λ_{cLHm} is obtained because the bandpass filter bandwidth is shifted, as the concept illustrated in the FIG. 11D.

Referring to FIG. 11D, FIG. 11D illustrates two examples of metasurface modules 60 with different thickness of the low refractive index material layer and the high refractive index material layer and their effect on longer central wavelength. The bottom panel shows the illustrative structures of the metasurface modules 60 which can be applied in the first example and the second example respectively in FIG. 11D. The difference between the metasurface modules 60 applied in the first example and the metasurface modules 60 applied in the second example is that the metasurface modules 60 applied in the second example has a thicker thicknesses of the high refractive index material layer 4H1 and a thicker thicknesses of the low refractive index material layer 4L1. Results show that as the thickness of the high refractive index material layer 4H1 and the low refractive index material layer 4L1 of DBR 1 increase, a longer central wavelength λ_{cLH1} is obtained.

The term “pair number of DBR” refers to a number of pair-repetition of high refractive index material layer and low refractive index material layer in each DBR. This is illustrated in an example as shown in FIG. 11E, the metasurface module 60A shows N is 2 in 3 DBRs configuration (see N₁=2 for DBR 1, N₂=2 for DBR 2, N₃=2 for DBR 3 as shown in the DBR layer 80 of the metasurface module 60A of FIG. 11E), and the metasurface module 60B shows pair number N is 3 in 3 DBRs configuration (see N₁=3 for DBR 1, N₂=3 for DBR 2, N₃=3 for DBR 3 as shown in the DBR layer 80 of the metasurface module 60B of FIG. 11E).

As shown in an example according to FIG. 11F, the module 60C having a DBR layer 80 alone without nanostructures 41 is just like a mirror and work as a bandpass filter to create a specific bandwidth. The metasurface module 60D has nanostructures 41 positioned on the top of DBR layer 80, and the nanostructures 41 are configured to create multi-bands within the bandwidth of the DBR layer 80 (which closely depend on thickness of high refractive index material layer and low refractive index material layer).

FIGS. 12A-12C illustrate examples of FIG. 10 when the pair number of DBRs is 10 with five bands (see FIG. 12A), 6 with three bands (see FIG. 12B), and 3 with two bands (see FIG. 12C), respectively. Wherein, the pair number of DBR means how many times low refractive index material layer and high refractive index material layer repeat in a DBR. In particular, the DBR composed of at least one pair of two materials having different refractive indices usually requires several tens of pairs of stacked structures in order to obtain a high reflectivity. It is noted that, the pair number of DBR can affect the width of the bands (reflection window). In particular, as the pair number of DBR increases, the width of the bands decreases (see FIGS. 12A-12C). The nanostructures 41 on the top of DBR is configured to distinguish the light into multiple color bands, and/or distinguish the light to be different cross-polarized. As the pair number of DBR increases, the number of the reflection from each layer increases too, therefore, their interactions with the nanostructures 41 on the top of the DBR will impact the number of the peaks and dips within the reflection window (bandpass filter bandwidth) the DBR created. That is, the number of bands of the light reflected by the metasurface module 60 can be determined by the pair number of DBR. In particular, as the pair number N of each DBR increases, the number of the bands increases.

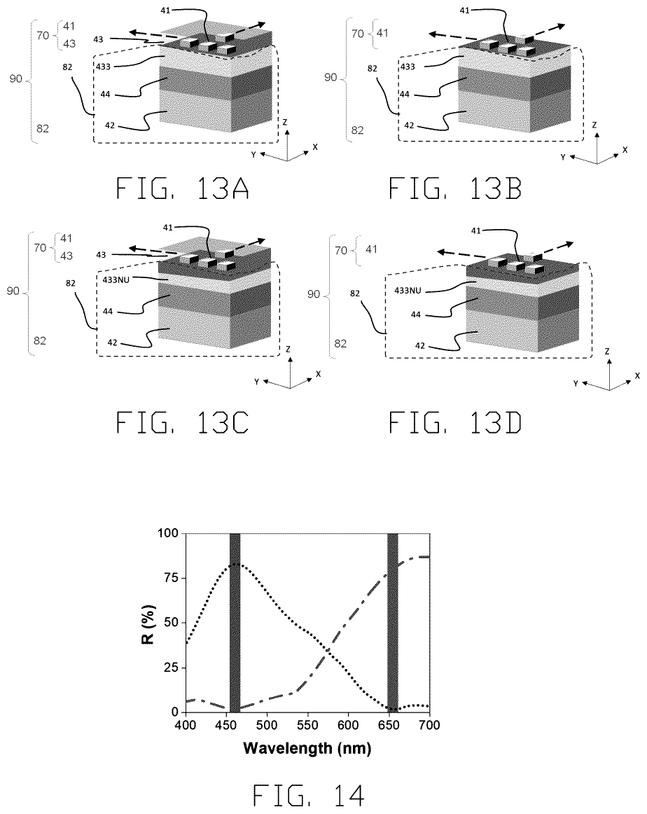

FIG. 13A shows an embodiment of a single-band metasurface module 90. The single-band metasurface module 90 of FIG. 13A comprises a metasurface layer 70 and a reflective layer 82. The metasurface layer 70 comprises nanostructures 41 and a cladding layer 43. The cladding layer 43 can be regarded as an impedance matching layer or as a part of other complimentary optical elements like a waveguide slab or it can be even air. The reflective layer 82 shows all the parts below the nanostructures 41. That is, the reflective layer 82 includes the spacer layer 433 to control the Fabry-Perot resonance, thick layer of reflective film 44, and the substrate 42. The thick layer of reflective film 44 can be a mirror which is made of a thick metal material like aluminum, silver, or gold. The substrate 42 can be made of SiO₂, silicon, and other materials. It can be understood that, the single-band metasurface module 90 of FIG. 13A does not include DBR.

FIG. 13B shows another embodiment of a single-band metasurface module 90. The difference between FIG. 13B and FIG. 13A is that the single-band metasurface module 90 of FIG. 13B does not comprise a cladding layer 43 as shown in FIG. 13A. The single-band metasurface module 90 of FIG. 13B comprises a metasurface layer 70 and a reflective layer 82. The metasurface layer 70 comprises nanostructures 41 without the cladding layer 43 as shown in FIG. 13A. The reflective layer 82 shows all the parts below the nanostructures 41. That is, the reflective layer 82 includes the spacer layer 433, thick layer of reflective film 44, and the substrate 42. The thick layer of reflective film 44 can be regarded as a mirror which is made of a thick metal material like aluminum, silver, or gold. The substrate 42 can be made of SiO₂, silicon, and other materials. It can be understood that, the single-band metasurface module 90 of FIG. 13B does not include DBR.

FIG. 13C shows a further embodiment of a single-band metasurface module 90. The difference between FIG. 13C and FIG. 13A is that the single-band metasurface module 90 of FIG. 13C further comprises non-uniform spacer layer 433NU. The single-band metasurface module 90 of FIG. 13C comprises a metasurface layer 70 and a reflective layer 82. The metasurface layer 70 comprises nanostructures 41 and a cladding layer 43. The cladding layer 43 can be regarded as an impedance matching layer or as a part of other complimentary optical elements like a waveguide slab or it can be even air. The reflective layer 82 shows all the parts below the nanostructures 41. That is, the reflective layer 82 includes the cladding layer 43, the spacer layer 433NU to control the Fabry-Perot resonance, the thick layer of reflective film 44, and the substrate 42. The thick layer of reflective film 44 can be a mirror which is made of a thick metal material like aluminum, silver, gold. The substrate 42 can be made of SiO₂, silicon, and other materials. It can be understood that, the single-band metasurface module 90 of FIG. 13C does not include DBR.

FIG. 13D shows a still embodiment of a single-band metasurface module 90. The difference between FIG. 13D and FIG. 13C is that the single-band metasurface module 90 of FIG. 13D does not comprise a cladding layer 43 as shown in FIG. 13C. The single-band metasurface module 90 comprises a metasurface layer 70 and a reflective layer 82. The metasurface layer 70 comprises nanostructures 41. The reflective layer 82 shows all the parts below the nanostructures 41. That is, the reflective layer 82 includes the spacer layer 433NU to control the Fabry-Perot resonance, the thick layer of reflective film 44, and the substrate 42. The thick layer of reflective film 44 can be a mirror which is made of a thick metal material like aluminum, silver, gold. The substrate 42 can be made of SiO₂, silicon, and other materials. It can be understood that, the single-band metasurface module 90 of FIG. 13D does not include DBR.

It can be understood that, the spacer layer 433 and the non-uniform spacer layer 433NU are configured to produce resonance to modulate the phase (amplitude) of the incoming light. It can be understood that, the difference between the reflective layer 82 (as shown in FIGS. 13A-13D) and the DBR layer 80 is that the reflective layer 82 does not include DBR.

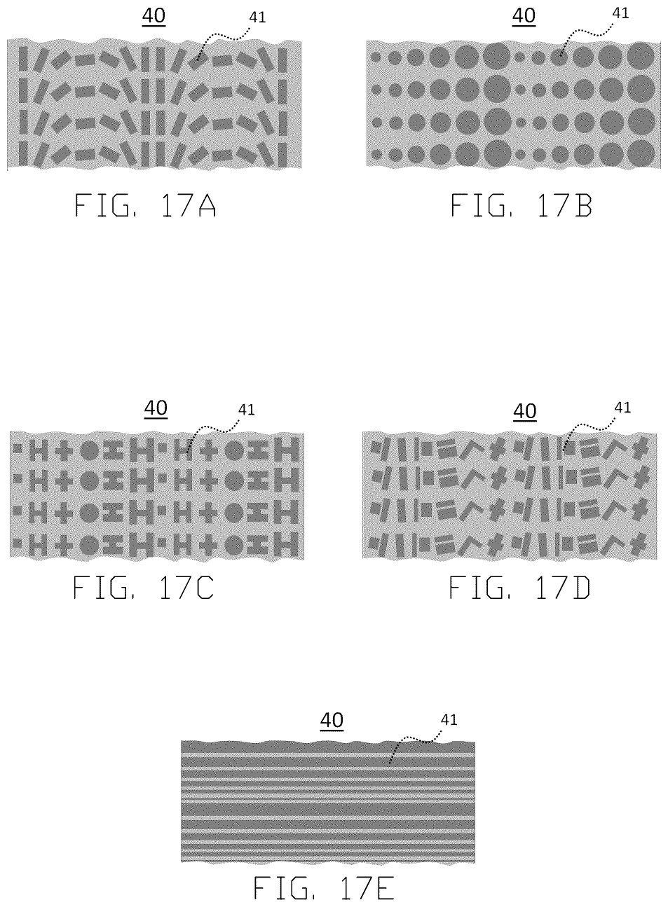

FIG. 14 illustrates an example of a single-band metasurface module 90 (such as single-band metasurface modules 90 shown in FIGS. 13A-13D, one for cyan color band (about 450 nm) and another for red color band (about 650 nm) with the at least overlapping band. Unlike FIG. 9, FIG. 10, and FIG. 11A which can produce multi-band using array of one type of nanostructures 41 with only one shape (for instance rectangular-shaped nanostructure such as the nanostructure 41 on shown in FIG. 17A), when there is no DBR underneath the nanostructure 41 (like the designs in FIGS. 13A-13D), the single-band metasurface module 90 will be able to excite and modulate only one peak in the reflection window (unlike FIG. 12A-12C) whose properties like bandwidth and amplitude is very limited to control. In addition, in order to create a color band of cyan and red, at least two different types of nanostructures 41 with different dimensions need to be used in the designs in FIGS. 13A-13D without DBR underneath the nanostructures 41. These single-band metasurface module 90 are designed to reveal minimum crosstalk. However, due to their wide band and low-quality resonances, the existence of the crosstalk is inevitable after fabrication.

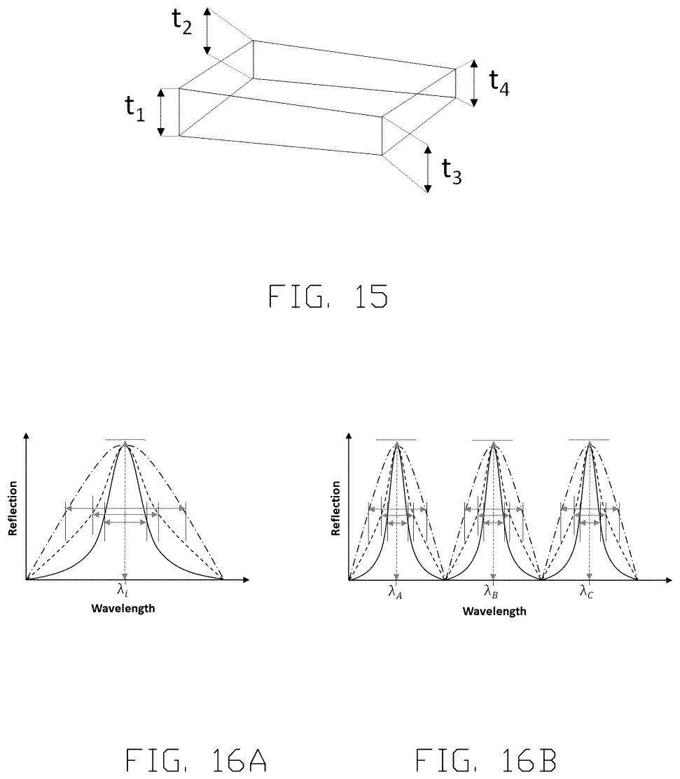

FIG. 15 illustrates a thickness of a unit of each layer provided by way of examples in FIG. 9, FIG. 10, FIG. 11A, FIGS. 13A-13D can be utterly uniform (t₁=t₂=t₃=t₄) or non-uniform (t₁≠t₂≠t₃≠t₄), or some can be uniform while the other non-uniform. For instance, the thicknesses of the substrate 42, the spacer layer 433, the cladding layer 43, DBRs in FIGS. 9-11A and spacer layer Sp in FIG. 11A can be non-uniform, and the thicknesses of the substrate 42, the thick layer of reflective film 44, the spacer layer 433, the cladding layer 43, the non-uniform spacer layer 433NU in FIG. 13A-13D can be non-uniform.

FIGS. 16A-16B illustrate full width at half maximum (FWHM) and amplitude engineering for a single band (see FIG. 16A) and multi-band (see FIG. 16B). Depending on tuning geometrical parameters (e.g., thickness, height, length, width, material) of each layer in FIGS. 13A-13D and FIG. 9, FIG. 10, and FIG. 11A, the bandwidth, FWHM, quality-factor, amplitude, and shifting the peaks to desired wavelengths like XA, B, and c can be possible as described in FIG. 9, FIG. 10 and FIG. 11A.

FIGS. 17A-17E illustrate five examples of nanostructure arrangement 40 and shapes which can vary from an isotropic shape all the way to an anisotropic shape or combination of isotropic and anisotropic shaped nanostructures 41.

FIG. 17A illustrates an embodiment of Pancharatnam-Berry (PB) phase arrangement 40 with the same anisotropic shape of nanostructures 41 disposed in the proposed metasurface module (not shown). The proposed metasurface module works based on the principle of having one type of nanostructures 41 to produce the phase change by copying while rotating the nanostructures 41 in a direction to form a supercell where a 2π phase change or higher becomes obtainable. The length and width of rectangular nanostructures 41 can vary from 20 nm to 550 nm if the desire spectrum is visible (or near-infrared or infrared), the height of the nanostructures 41 can have a value of 20 nm to 3000 nm. It worth mentioning that the working range of the proposed metasurface module is scalable. In addition, if the nanostructures 41 are properly designed, the metasurface module with the nanostructures 41 can work at different wavelengths.

FIG. 17B illustrates another embodiment of propagation phase arrangement 40 with isotropic nanostructures 41 disposed in the proposed metasurface module (not shown). The proposed metasurface module works based on producing the required phase change by varying the isotropic nanostructure's dimensions. Here the radius of the nanopillars can vary from 10 nm to 400 nm if the desire spectrum is visible (or near-infrared or infrared), the height of the nanostructures 41 can have a value of 20 nm to 3000 nm. It worth mentioning that working range of the proposed metasurface module is scalable. In addition, if the nanostructures are properly designed, the metasurface module with the nanostructures 41 can work at different wavelengths.

FIG. 17C illustrates a further embodiment of complex-shaped nanostructures arrangement 40 of the deflecting metasurface module (not shown) in which the required phase change is achieved through different anisotropic nanostructures 41 with different shapes, whose dimensions are smaller than the pitch (Pcc or P_{EE}) described in FIGS. 6A-6C. Where the pitch can have a value from 150 nm to 800 nm. If the desire spectrum is visible (or near-infrared or infrared), the height of the nanostructures can have a value of 20 nm to 3000 nm. It worth mentioning that the working range of the proposed metasurface module is scalable. In addition, if the nanostructures 41 are properly designed, the metasurface module with the nanostructures 41 can work at different wavelengths.

FIG. 17D illustrates a still embodiment of complex-shaped nanostructures arrangement 40 of the deflecting metasurface module (not shown) including PB-phase and propagation phase schemes including both isotropic and anisotropic nanostructures 41 such as the ones described in FIGS. 5A-5F. Where the required phase change is obtained via the above-mentioned nanostructures 41, whose dimensions are smaller than the pitch (Pcc or P_{EE}) described in FIGS. 6A-6C. Where the pitch can have a value from 150 nm to 800 nm. If the desire spectrum is visible (or near-infrared or infrared), the height of the nanostructures 41 can have a value of 20 nm to 3000 nm. It worth mentioning that the working range of the proposed metasurface module is scalable. In addition, if the nanostructures 41 are properly designed, the metasurface module with the nanostructures 41 can work at different wavelengths.

FIG. 17E illustrates a still embodiment of the arrangement 40 with metagratings-structured nanostructures 41 of the deflecting metasurface module (not shown) for deflecting the light. The widths of metagratings-structured nanostructures 41 should be smaller than the pitch (Pcc or P_{EE}) described in FIGS. 6A-6C. Where the pitch can have a value from 150 nm to 800 nm. If the desire spectrum is visible (or near-infrared or infrared), the height of the nanostructures 41 can have a value of 20 nm to 3000 nm. It worth mentioning that the working range of the proposed metasurface module is scalable. In addition, if the nanostructures 41 are properly designed, the metasurface module can work at different wavelengths. It is noted that the grating bars can be continuous or can be discrete like Catenary configuration.

FIGS. 18A-18E illustrate the proposed metasurface module depends on the applications can be designed as a deflecting metasurface, metalens, orbital angular momentum generator or sorter, and so on and it can be polarization dependent or independent.

FIG. 18A illustrates a schematic diagram on the working principle of the proposed metasurface module 60. Once a broadband light forms a light source (not shown) or a display (not shown) illuminates the metasurface module 60, the metasurface module 60 segregates the broadband into a specific number of bands (depending on the design of the metasurface module 60) and reflect the light to the designated angle. In particular, in the embodiment of the present disclosure, the metasurface module 60 comprises a metasurface layer 70 and DBR layer 80. Wherein, the metasurface layer 70 comprises nanostructures 41 and a cladding layer 43. It can be understood that, in other embodiments, the metasurface module 60 without the cladding layer 43 can also be applied in the embodiment of FIG. 18A.

FIG. 18B illustrates schematic diagram of working principle of 3D AR glasses 100 in which each eye has different color bands compared to another eye. In particular, in 3D AR glasses 100, each eye has chromatically opposite color bands compared to another eye. Where R, G, B, C, M, and Y in FIG. 18B represent red, green, blue, cyan, magenta, yellow color bands respectively. The light can be cross-polarized from one eye to another. For example, when one eye receives right-handed circularly polarized (RCP) light and another eye receives left-handed circularly polarized (LCP). However, the 3D AR glasses 100 can be designed in such a way both eyes can support the same type of the polarization. The 3D AR glasses 100 also supports both linear and circular polarizations or it can be designed to be polarization independent. By carefully tuning the DBR and metasurface geometrical parameters, three color bands which cover the desired color bands for the left eye (e.g. red, green, and blue) are created and one or three complimentary color bands are created for the right eye (e.g. cyan, magenta, yellow). In particular, an optical device for 3D imaging is disclosed, wherein the optical device can be such as 3D AR glasses 100 in FIG. 18B. The optical device comprises two different metasurface module (not shown, such as metasurface module 60 shown in FIG. 18A). One of two different metasurface module is configured to create one or more color bands for left eye and the other of the two different metasurface module is configured to create one or more different color bands for right eye. In some embodiments, the two different metasurface module of the optical device have different DBRs to create different color bands for two eyes. In some embodiments, the two different metasurface module of the optical device have different metasurface layer (or nanostructures 41) to create different color bands for two eyes. In some embodiments, the two different metasurface module of the optical device have different DBRs and/or different metasurface (or nanostructures 41) to create different color bands for two eyes. Wherein, the different color bands created by the two different metasurface module of the optical device for two eyes can be any complimentary color bands to each other.

FIG. 18C illustrates a schematic diagram of reflection window (like a bandpass filter) design of Distributed Bragg reflector (DBR) band tuning using different layers of repeated pairs of high refractive index material layer and low refractive index material layer. Top panel shows a narrow reflection window when only one DBR used. Middle panel shows a broader reflection window when two DBRs used in which two overlapping narrow-band DBRs are merged to create a wider reflection window. Bottom panel shows the broadest reflection window when three DBRs used in which three overlapping narrow-band DBRs are merged to create a super wide reflection window. However, it is not limited to only 3 DBRs.

When two DBRs consist of the same materials but different central wavelengths (λ_{cLH}) with certain shift are carefully combined, a wide reflection window appears which is result of overlapping DBR bands to form a wider band which has more freedom compared to a technique in which only one pair of high refractive index material layer and low refractive index material layer in a DBR is used with higher contrast between its high refractive index and low refractive index. For example, a DBR with pair of high refractive index material layer and low refractive index material layer made of SiO₂/α-Si has broader reflection band compared to a lower contrast material like SiO₂/HfO₂ or SiO₂/Ta₂O₅. Bandwidth of the reflection window (Δλ) is a function of the pair's refractive indices as given Δλ=(4*_{cLH}/π)*arcsin((n_{H}−n_{L})/(n_{H}+n_{L})). Therefore, when the refractive index difference between high refractive index material layer and low refractive index material layer becomes larger (n₂−n₁), the reflection window becomes wider. However, DBRs with high contrast materials or even different materials form a super wide reflection window. Therefore, by tuning the design parameters in DBR and their materials, a wide reflection band can be obtained. Then, there is a need for an array of nanostructures 41 to form multi-resonance (multi-band) scheme within the reflection window of the DBR.

FIG. 18D illustrates simulated result of at least one DBR-based deflecting metasurface module (not shown). In the top panel, the DBR-based deflecting metasurface module passes blue, green and red color bands. While, the bottom panel represents another DBR-based deflecting metasurface module to work at cyan and yellow color bands. As shown, the band overlapping for the left and right eyes are minimized. In particular, the visible light and complimentary color bands are limited, therefore, the number of color bands is limited in the visible spectrum. Thus, 1 to 3 color bands for one eye and 1 to 3 color bands for another eye. FIG. 18D shows at least two metasurface module (combination of DBR and metasurface) can support 5 different color bands, wherein 3 color bands for the left eye and 2 color bands for the right eye. For the left-eye, therefore, a DBR with broader bandwidth is needed for 3 color bands. In addition, for the right eye, a different DBR with narrower bandwidth is needed for only two-color bands. In particular, the term “different DBRs” means different design, different central wavelength, different thicknesses for high refractive index material layer and low refractive index material layer. The number of peaks is also different for the left eye (three peaks) and for the right eye (two peaks) which means different pair number of DBR. However, the nanostructure 41 can be considered to have some differences in the left and right eyes. In other embodiments, if 1 or 2 color bands only for one eye and 1 or 2 color bands for another eye, only one DBR in two metasurface module (one metasurface module for one eye, and another metasurface module for another eye) can be used to limit ourselves to the desired color bands, then different metasurface layers (or nanostructures 41) in two metasurface modules are used to choose the exact desired color band, in order to create different color bands for two eyes.

FIG. 18E illustrates the phase coverage corresponding to the color bands presented in FIG. 18D. All the color bands support 2π (and beyond) phase gradient which lead to full control of the light at different color bands unlike simple reflective design shown in FIGS. 13A-13D which usually supports the phase gradient of only one broad band at the time.

Top left panel of FIG. 18F shows 3 times pair repetition (N₁=3) of high refractive index material layer and low refractive index material layer in a DBR, according to an embodiment. Top middle panel of FIG. 18F shows 6 times pair repetition (N₁=6) of high refractive index material layer and low refractive index material layer in a DBR, according to an embodiment. Top right panel of FIG. 18F shows 9 times pair repetition (N₁=9) of high refractive index material layer and low refractive index material layer in a DBR, according to an embodiment. Bottom panel of FIG. 18F shows the cut-off of DBR windows with different times pair repetition of high refractive index material layer and low refractive index material layer in a DBR, according to an embodiment. Bottom panel of the plot in FIG. 18F shows the cut-off of DBR windows with different pair repetition of high refractive index material layer and low refractive index material layer in the DBR, according to embodiments of top left panel, top middle panel, and top right panel of FIG. 18F.

As shown in examples according to FIG. 18F, as pair number N₁ of DBR increases, the cut-off of DBR window become more square-shape and the cut-off frequency and becomes more accurate. Wherein, the cut-off refers to a position that the bandpass filter starts or ends. In addition, when pair number N₁ of DBR is not large enough, the starting and the ending of the band is curved and the efficiency of the DBR is not sufficient.

FIGS. 19A-19C illustrate schematic diagrams of the potential applications of at least one metasurface module of an optical device (not shown) in waveguide, pancake or aspheric lenses, and birdbath or freeform optical elements. As shown in FIGS. 19A-19C, the at least one metasurface module can comprise a first metasurface module 60E configured to create one or more color bands (such as R, G, B) for left eye and a second metasurface module 60F configured to create one or more different color bands (such as Y, M, C) for right eye. Wherein, the different color bands created by the first metasurface module 60E and second metasurface module 60F of the optical device for two eyes can be any complimentary color bands to each other. Where R, G, B, C, M, and Y in FIGS. 19A-19C represent red, green, blue, cyan, magenta, yellow color bands respectively. FIG. 19A illustrates at least one metasurface module of an optical device (not shown) in waveguide, the angle of incident respect to the at least one metasurface module (i.e., the first metasurface module 60E and second metasurface module 60F) should be well-controlled. A tuning stage 61 could move or rotate the at least one metasurface module mechanically or electrically. FIG. 19B illustrates at least one metasurface module (i.e., the first metasurface module 60E and second metasurface module 60F) of an optical device (not shown) with pancake or aspheric lenses in which the display 10 is located off the center to ensure the at least one metasurface modules (i.e., the first metasurface module 60E and second metasurface module 60F) work compatible with pancake or aspheric lenses design. A tuning stage 61 could move or rotate the at least one metasurface module mechanically or electrically. FIG. 19C illustrates at least one metasurface module (i.e., the first metasurface module 60E and second metasurface module 60F) of an optical device (not shown) with birdbath or freeform optical elements. Wherein, the at least one metasurface module (i.e., the first metasurface module 60E and second metasurface module 60F) can be placed in the first reflective surface (as shown in the schematic diagram) or in the second reflective surface (if any). A tuning stage 61 could move or rotate the at least one metasurface module mechanically or electrically.

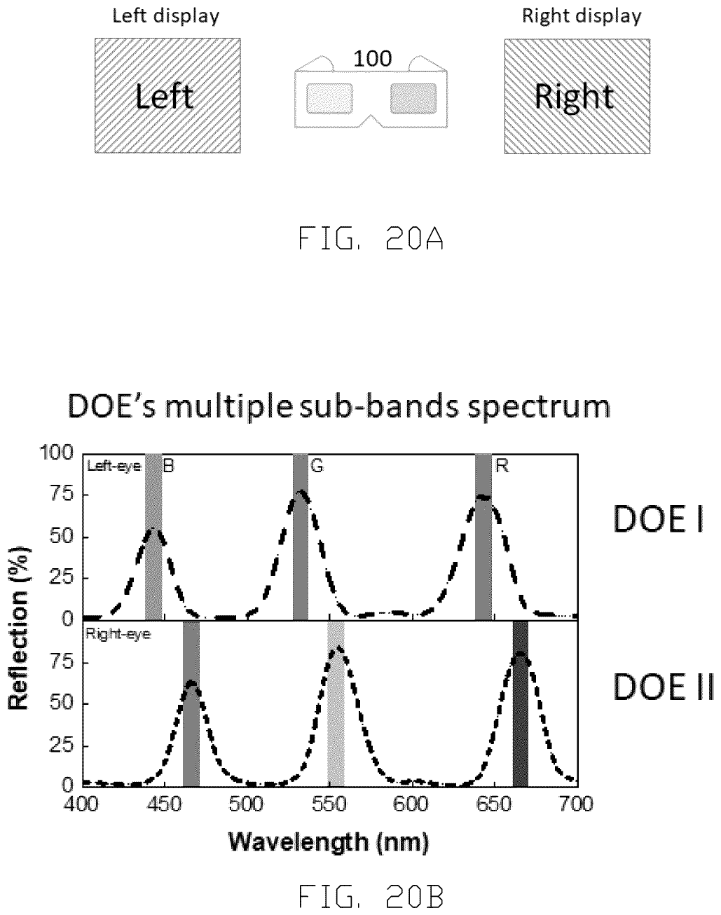

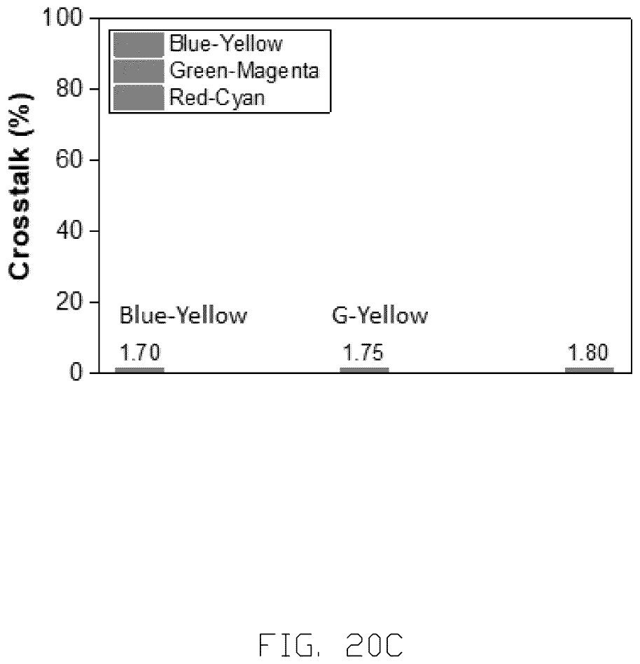

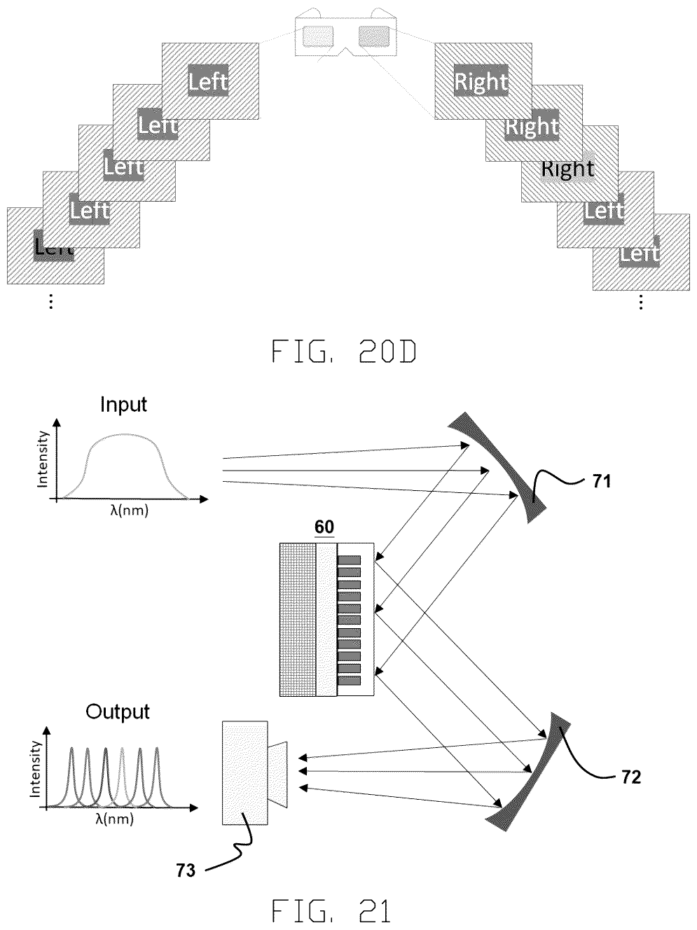

FIGS. 20A-20D illustrate one application of the proposed metasurface module applied to an optical device. For example, the proposed metasurface modules are designed for the color arrangement and crosstalk of the pair of glasses for right and left eye. FIG. 20A illustrates a schematic diagram of a 3D glasses 100 with two displays to produce a consistent disparity for left and right eyes following by color mapping algorithm to make sure a true color production is obtainable while considering the depth continuity and active depth cut. In addition, the 3D glasses 100 of FIG. 20A can be applied to the schemes of FIGS. 19A-19C. Furthermore, a field-sequential color system can be built up upon the proposed metasurface module to further reduce the color breakup and providing higher optical output and spatial resolution, and wide color gamut. In case of LBS display a Lissajous scanning technique can be utilized to further align the colors and enhance the image quality through the software. The corresponding reflection spectra of each eye's diffractive optical element (DOE) which in this case is our proposed metasurface module has shown in FIG. 20B, the top panel is for the left eye and bottom panel is for the right eye. The crosstalk can be minimized if one carefully designs the DBR-based metasurface module (see FIG. 20C), therefore, different scenarios are applicable as shown in FIG. 20D from top to bottom cyan-red, green-magenta, blue-yellow, blue & green-blue & red, amber-blue. However not limited to these combinations. It's noted that for each eye there can be one metasurface module or more than one.

FIG. 21 illustrates another application of the proposed DBR-based metasurface module 60 applied to optical detection device, such as orbital angular momentum (OAM) generator or sorter, metalenses, spectroscopy application like Raman spectroscopy and sensing such as time of flight (ToF). It is feasible to replace the conventional grating with the proposed metasurface module 60, to split the spectrum bands with much higher resolution. In FIG. 21, the proposed DBR-based metasurface module 60 can be applied to an optical device (not shown), optical device (not shown) can include a light source (not shown, or a display), at least one concave lens (such as concave lenses 71 and 72), the proposed metasurface module 60 and a detector 73. The light emitted from a light source (not shown) or a display (not shown) is reflected by the concave lens 71, then the metasurface module 60 reflects the reflected light toward the concave lens 72. Then, the concave lens 72 reflects the reflected light toward the detector 73. The metasurface module 60 is configured to distinguish the light into multiple color bands and/or distinguish the light to be different cross-polarized, therefore the detector 73 can receive the light with multiple color bands and/or the light with different cross-polarized. Moreover, the metasurface module 60 can be made with or in combination with active materials as explained earlier, enabling even more versatile options for tuning and calibrating the spectroscopy.

Spectrometry measures the irradiance alteration in the wavelength domain, which can provide information corresponded to the chemical composition of the material. Therefore, depending on the dissolving power of the diffuser, more data from two materials with slightly different chemical compounds can be distinguished. Available reflective blazed gratings are usually fabricated on convex surfaces which higher the risk of fabrication imperfection. However, there are some blazed gratings fabricated on a flat surface which suffer from low optical performance. Moreover, the calibration of the conventional diffractive diffusers is challenging and the reflection may change over the course of the time and its long-term stability is also controversial and if they are not well-manufactured they may suffer from chromatic and axial aberration, sagittal field curvature and other types of aberration or distortion. Therefore, a hyperspectral DBR-based metasurface module 60 as a diffuser is introduced. The DBR-based metasurface module 60 requires a simple manufacturing with high tolerance for fabrication error, simple calibration in an active mode, super-fine resolving power which can be designed based on the required resolution in each system (such as the embodiment in FIGS. 12A-12C).

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A metasurface module comprising:
a distributed Bragg reflector (DBR) layer, the DBR layer comprising at least one DBR; and
a metasurface layer arranged on the DBR layer, the metasurface layer comprising:
a plurality of nanostructures arranged on the DBR layer, the plurality of nanostructures arranged in a predetermined configuration, the plurality of nanostructures configured to change a light modulation of lights emitted from a light source and separate a spectral of the light to a plurality of specific bands.

2. The metasurface module according to claim 1, wherein the metasurface layer further comprises a cladding layer coating over the plurality of nanostructures.

3. The metasurface module according to claim 1, wherein the metasurface layer further comprises a residual resin mixture arranged between the plurality of nanostructures and the DBR layer.

4. The metasurface module according to claim 1, wherein the at least one DBR is consisting essentially of at least one pair of high refractive index material layer and low refractive index material layer.

5. The metasurface module according to claim 1, wherein the plurality of nanostructures are made of a phase changing material.

6. The metasurface module according to claim 1, wherein the plurality of nanostructures are made of high refractive index resin or metal oxide nanoparticles.

7. The metasurface module according to claim 1, wherein each of the plurality of nanostructures is in an isotropic, an anisotropic, or a combination of isotropic and anisotropic shapes.

8. The metasurface module according to claim 1, wherein the DBR layer comprises a plurality of DBRs, each of the plurality of DBRs comprises different pair number of high refractive index material layer and low refractive index material layer.

9. The metasurface module according to claim 1, further comprising:
at least one spacer layer disposed under the plurality of nanostructures.

10. The metasurface module according to claim 9, wherein each of the plurality of DBRs are overlapped arranged and spaced apart by the at least one spacer layer.

11. An optical device comprising:
at least one light source emitting lights;
at least one metasurface module receiving the lights from the at least one light source, the at least one metasurface module configured to reflect the lights to a target, change a light modulation of the lights and separate a spectral of the light to a plurality of specific bands, the at least one metasurface module comprising:
a distributed Bragg reflector (DBR) layer; and
a metasurface layer arranged on the DBR layer, the metasurface layer comprising:
a plurality of nanostructures arranged on the DBR layer, the plurality of nanostructures arranged in a predetermined configuration.

12. The optical device according to claim 11, further comprising at least one coupler, wherein the at least one coupler is configured to polarize the lights reflected from the at least one metasurface module to the target.

13. The optical device according to claim 11, further comprising at least one pancake lens, wherein the at least one pancake lens is configured to transmit through the lights reflected from the at least one metasurface module to the target.

14. The optical device according to claim 11, further comprising at least one free-form optical element, wherein the at least one free-form optical element is configured to transmit through the lights reflected from the at least one metasurface module to the target.

15. The optical device according to claim 11, further comprising a lens-set, an optional polarizer, and a controller, wherein the lens-set and the optional polarizer are arranged spaced between the at least one light source and the at least one metasurface module and aligned with the at least one light source, the lens-set is configured to collimate and transmit the lights emitted from the at least one light source to the optional polarizer, the optional polarizer is configured to polarize the lights from the lens-set to the at least one metasurface module, the controller is equipped with the at least one metasurface module, the controller is configured to electrically or mechanically control the metasurface module.

16. The optical device according to claim 11, wherein the metasurface layer further comprises a cladding layer coating over the plurality of nanostructures.

17. The optical device according to claim 16, wherein the metasurface layer further comprises a residual resin mixture arranged between the plurality of nanostructures and the DBR layer.

18. The optical device according to claim 11, wherein the plurality of nanostructures are made of a phase changing material.

19. The optical device according to claim 11, wherein the plurality of nanostructures are made of high refractive index resin or metal oxide nanoparticles.

20. The optical device according to claim 11, wherein the optical device is AR/VR/MR glasses or an optical detection device.
